(19) United States
(12) Patent Application Publication
(10) Pub. No.: US 2026/0118582 A1
(43) Pub. Date: Apr. 30, 2026

(54) DEVICE AND METHOD FOR HYBRID BONDING IN PHOTONIC INTEGRATED CIRCUITS

(71) Applicant: MIXX TECHNOLOGIES, INC., San Jose, CA (US)

(72) Inventors: Rebecca Kayla Schaevitz, Sunnyvale, CA (US); Vivek Raghuraman, San Jose, CA (US); Qijun Xiao, Fremont, CA (US)

(73) Assignee: MIXX TECHNOLOGIES, INC., San Jose, CA (US)

(21) Appl. No.: 19/373,414

(22) Filed: Oct. 29, 2025

Related U.S. Application Data
(60) Provisional application No. 63/713,260, filed on Oct. 29, 2024.
(60) Provisional application No. 63/720,136, filed on Nov. 13, 2024.

(51) Int. Cl. G02B 6/122; G02B 1/00; G02B 1/11; G02B 6/12; G02B 6/136

(52) U.S. Cl. CPC G02B 6/1223; G02B 1/002; G02B 1/11; G02B 6/136; G02B 2006/12061; G02B 2006/12104; G02B 2006/12197

(57) ABSTRACT

Devices and methods for photonic integrated circuits are provided. A device may include a silicon wafer substrate having one or more angled facet(s); a coating applied to the angled facet; and an oxide layer to form a planar surface to enable hybrid and/or fusion bonding. A method may include: etching a first silicon wafer to create one or more sloped sidewalls, an angle of the one or more sloped sidewalls being determined by a crystallographic orientation of the silicon wafer and/or advanced lithography processes such as greyscale or nano-imprint lithography; depositing a coating on at least one sloped sidewall of the one or more sloped sidewalls to create a surface for manipulating the light within the photonic structure; and enabling a final surface that allows for integration with a photonic integrated circuit (PIC) through hybrid and/or fusion bonding.

### RELATED APPLICATION

This application claims the benefit of U.S. Provisional Application No. 63/713,260, filed Oct. 29, 2024, and U.S. Provisional Application No. 63/720,136, filed Nov. 13, 2024, the disclosures of which are incorporated herein by reference in their entireties for all purposes.

### BACKGROUND

Unless otherwise indicated herein, the materials described herein are not prior art to the claims in the present application and are not admitted to be prior art by inclusion in this section.

Photonic Integrated Circuits (PICs) may be used in applications with high-speed data processing and transmission, including telecommunications, data centers, and advanced sensing systems. PICs may integrate multiple optical components on a single chip, allowing for compact, energy-efficient designs that may handle large amounts of data. One aspect of PIC design involves incorporating optical structures, such as mirrors and lenses, which redirect or reshape light to facilitate precise coupling and alignment within the circuit. These optical structures may be used to guide light paths and achieve enhanced performance and testing across the chip.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

Provided herein is a method and structure for forming optical device(s) within a silicon substrate that can subsequently avoid the use of optical epoxies and instead use hybrid or fusion bonding or similar to integrate with photonic integrated circuits (PICs).

The optical device may include several features, such as cavities, protrusions, angled side walls, anti-reflective (AR) coatings or embedded AR structures, high-reflective (HR) coatings or embedded HR structures, meta-surfaces, wavelength-dependent structures, polarization-dependent structures, and optical facets. These features may serve the purpose of reflecting light, multiplexing (muxing) or de-multiplexing (demuxing) wavelengths of light, splitting or combining polarizations of light, reducing reflections, reshaping or redirecting light. To facilitate the formation of these structures, processes such as wet or dry etching, greyscale lithography, nano-imprint lithography (NIL), chemical-mechanical polishing (CMP), oxidation, deposition, hybrid or fusion bonding or similar may be used. The resulting optical device(s) may then be integrated with a PIC through hybrid or fusion or similar bonding to enable a seamless, optical epoxy-free, final device capable of low loss (<3 dB), high-power (>50 mW), polarization-independent, broadband (e.g. 1200 nm-1600 nm) optical transmission.

The optical device(s) may use several materials, including, but not limited to, one or more of silicon (Si), silicon dioxide (SiO₂), silicon nitride (Si₃N₄), titanium dioxide (TiO₂), tantalum oxide (Ta₂O₅), aluminum oxide (Al₂O₃), hafnium oxide (HfO₂), zinc sulfide (ZnS), copper (Cu), aluminum (Al), gold (Au), or silver (Ag). These materials are deposited using methods such as plasma-enhanced vapor deposition (PECVD), low-pressure CVD (LPCVD), e-beam evaporation, ion-assisted deposition (IAD) or atomic layer deposition (ALD) to form the precise thicknesses and planarity used for optical performance, whether it is to form reflective, anti-reflective, polarization-dependent, wavelength-dependent, phase-dependent or meta-surfaces.

One example of a process to make a device that can later be integrated via hybrid or fusion bonding is as follows. First one or more of a wet-etched angle cavity is formed to a specific angle due to the crystalline orientation of the silicon. This orientation may be specified by the original seed growth of the ingot and/or through off-axis dicing. A thermal oxide layer may be grown on the flat surface of the silicon substrate, including within a wet-etched angled cavity, to create a smooth, planar, defect-free bonding surface. Several more layers of materials with varying refractive indices may then be deposited to form a high-reflectivity mirror surface such that the angled cavity forms a mirror. Another thicker layer of oxide may be deposited for structural integrity and planarization of the surface for further processing. The final oxide layer may also serve as an insulating medium, supporting through-dielectric vias (TDVs) that may provide vertical electrical connectivity. A handle silicon wafer, with or without electrical vias, may be bonded via fusion or hybrid bonding to the backside of the oxide layer, offering structural stability during fabrication and assembly processes as well as optionally electrical connectivity to external components in the final product, supporting complex interconnections in high-density PIC layouts.

A second example of a process to make a device that can later be integrated via hybrid or fusion bonding is as follows. A method may include positioning silicon and oxide layers, bonding a silicon carrier to the structure, inverting the structure, and then thinning the silicon layer through backgrinding or chemical-mechanical polishing (CMP) or similar processes to form an anti-reflective (AR) dielectric stack. The method may continue with the etching of one or more of a facet for light coupling and the further application of the AR coatings on that facet as well as etching of one or more of a facet for a mirror surface, whether through total internal reflection (TIR) or through the application of high-reflectivity coatings (e.g. dielectric stacks and/or metal). The method may allow for variations in facet angles and bias-cut silicon, providing flexibility in design and optimizing optical performance for specific applications. The AR coating may be revealed at a later stage in the process, after backgrinding or CMP and/or wet etching to remove the original handle silicon wafer, providing minimal reflection loss across various interfaces to differing refractive index materials in the optical path, such as lenses or fiber. An embedded AR stack, formed through layers of silicon and oxide, may be configured to match the refractive index of adjacent materials like air, silicon nitride, or fused silica, providing superior optical coupling and broader design flexibility.

### BRIEF DESCRIPTION OF THE DRAWINGS

So that the manner in which the above recited features of the present disclosure can be understood in detail, a more particular description of the disclosure, briefly summarized above, may be had by reference to examples, some of which are illustrated in the appended drawings. It is noted, however, that the appended drawings illustrate only some aspects of this disclosure and the disclosure may admit to other equally effective examples.

To facilitate understanding, identical reference numerals have been used, where possible, to designate identical elements that are common to the figures. It is contemplated that elements and features of one example may be beneficially incorporated in other examples without further recitation.

FIGS. 1A-1D are schematics of an exemplary method for fabricating a semiconductor device having an embedded AR stack;

FIGS. 2A-2D are schematics of exemplary method for fabricating a semiconductor device having an embedded AR stack;

FIGS. 3A-3D are schematics of exemplary semiconductor devices showing the light path once integrated with a PIC and having embedded AR, Mux/Demux, HR and meta-surfaces.

FIGS. 4A-4H are schematics of an exemplary method for fabricating an optical device configured for hybrid bonding;

FIGS. 5A-5E are schematics of an exemplary method for fabricating an optical device configured for hybrid bonding;

FIGS. 6A-6H are schematics of an exemplary method for fabricating an optical device configured for hybrid bonding;

FIGS. 7A-7C are schematics of an exemplary method for fabricating an optical device configured for hybrid bonding;

FIGS. 8A-8C are schematics of exemplary semiconductor devices showing the light paths once integrated with a PIC.

FIGS. 9A-9G are schematics of exemplary semiconductor devices showing the light paths once integrated with a PIC.

### DETAILED DESCRIPTION

The present disclosure will now be described in detail with reference to the drawings, which are provided as illustrative examples of the disclosure so as to enable those skilled in the art to practice the disclosure. Notably, the figures and examples below are not meant to limit the scope of the present disclosure to a single example, but other examples are possible by way of interchange of some or all of the described or illustrated elements. Moreover, where certain elements of the present disclosure can be partially or fully implemented using known components, only those portions of such known components that are necessary for an understanding of the present disclosure will be described, and detailed descriptions of other portions of such known components will be omitted so as not to obscure the disclosure.

As used herein, the singular form of “a”, “an”, and “the” include plural references unless the context clearly dictates otherwise. As used herein, the statement that two or more parts or components are “coupled” shall mean that the parts are joined or operate together either directly or indirectly (i.e., through one or more intermediate parts or components, so long as a link occurs). As used herein, “directly coupled” means that two elements are directly in contact with each other. As used herein, “fixedly coupled” or “fixed” means that two components are coupled so as to move as one while maintaining a constant orientation relative to each other. As used herein, “operatively coupled” means that two elements are coupled in such a way that the two elements function together. It is to be understood that two elements “operatively coupled” does not require a direct connection or a permanent connection between them. As utilized herein, “substantially” means that any difference is negligible, or that such differences are within an operating tolerance that are known to persons of ordinary skill in the art and provide for the desired performance and outcomes as described in one or more embodiments herein. Descriptions of numerical ranges are endpoints inclusive.

As used herein, the word “unitary” means a component is created as a single piece or unit. That is, a component that includes pieces that are created separately and then coupled together as a unit is not a “unitary” component or body. As employed herein, the statement that two or more parts or components “engage” one another shall mean that the parts exert a force against one another either directly or through one or more intermediate parts or components. As employed herein, the term “number” shall mean one or an integer greater than one (i.e., a plurality). Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

Examples described as being implemented in hardware should not be limited thereto, but can include examples implemented in software, or combinations of software and hardware, and vice-versa, as will be apparent to those skilled in the art, unless otherwise specified herein. In the examples described herein, an example showing a singular component should not be considered limiting; rather, the invention is intended to encompass other examples including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The formation of optical structures (e.g., mirrors and/or lenses) within PICs presents different challenges. Most techniques often rely on optical epoxy, which may suffer from alignment limitations and may be sometimes unable to endure the thermal stresses experienced during fabrication and operation. Additionally, these epoxies may yellow or degrade over time and fail in high optical power scenarios. For example, some reflector or lens integration methods may lead to optical misalignment or structural instability under thermal cycling, impacting the overall optical performance of the PIC. Additionally, these methods may involve multiple post-fabrication steps to fine-tune alignment or improve structural durability, adding complexity, time and cost to the manufacturing process.

In addition, photonic devices frequently encounter challenges related to reflection losses due to mismatches in refractive indices between various materials. For instance, silicon, with a refractive index (n) of approximately 3, may be used in combination with other materials like silicon nitride (n≈2) and fused silica (n≈1.5) and air (n=1). These mismatches may lead to significant back reflections and optical losses at the interfaces between these materials, reducing overall device performance. Anti-reflective (AR) coatings may sometimes be applied to external facets to minimize these losses, but this solution may be impractical in processes where the surface is later removed or modified, such as in backgrinding or chemical-mechanical polishing (CMP). Some AR coating methods may focus on treating the exposed facets of devices after the main processing steps are complete, which limits their effectiveness in multi-layered photonic structures. In devices where surfaces undergo additional processing, such as thinning or backgrinding, the external AR coatings may be either destroyed or rendered ineffective, leading to reflection issues that degrade signal integrity and efficiency.

The disclosure presented provides a reliable method for forming optical structures in photonic integrated circuits (PICs) with precise alignment and high optical performance incorporating optical epoxy-free (as used herein, “epoxy-free” or “non-epoxy” means without the use of optical epoxy and may be used interchangeably) hybrid (oxide+metal) or fusion (oxide-only) or similar (e.g. bonding films that mimic hybrid or fusion) bonding. This process may facilitate integration of reflector, beam-shaping, multiplexing, demultiplexing, polarization splitting/combining, and anti-reflection elements to ensure a high-quality signal path. Additionally, these examples support high-throughput wafer-level manufacturing, making them scalable for commercial production. The described processes enhance the efficiency, stability, and optical integrity of PICs, to provide use in modern high-performance photonic applications.

To reduce reflections that could degrade signal quality, a method for embedding anti-reflective (AR) functionality directly within photonic devices via an embedded AR stack may be provided, offering a solution to minimize reflection loss and maximize optical performance. AR coating may be a thin, multi-layered optical coating applied to surfaces to reduce unwanted reflections and glare. One function of AR coating may be to improve the transmission of light through the surface by minimizing reflections that may cause loss or interference that may degrade the optical signal.

Reducing reflections through the use of AR coatings may be advantageous for enhancing the efficiency of light transmission between integrated photonic components with differing refractive indices, such as air, waveguides, lenses, and optical fibers. Such AR coating may reduce optical losses, ensuring higher precision and performance in devices like optical transceivers and lasers. For example, AR coatings may enhance the sharpness and clarity of signals by enhancing the contrast of transmitted light, leading to more accurate signal processing in devices like PICs and optical sensors. By allowing more light to pass through surfaces without reflection, AR coatings may be advantageous in optical semiconductor devices where maximizing light transmission is useful for performance, which may be particularly advantageous in applications such as high-speed data transmission and optical communications.

However, most AR coatings may be limited to external application, which is ineffective in processes involving surface removal, such as etching, backgrinding or chemical-mechanical polishing (CMP). Accordingly, the disclosure herein may integrate an embedded AR stack (embedded may mean positioned inside or within the photonic structure) that may function similar to or the same as AR coating, ensuring that AR functions remains intact and functional throughout manufacturing processes, providing precision and efficiency in optical coupling. An embedded AR stack may include layers of materials with varying refractive indices, configured to cancel out reflected light through destructive interference. Such embedded AR stack may optimize the overall optical efficiency of semiconductor devices by reducing signal loss and enhancing light throughput.

Moreover, by using layers of differing refractive indices, such as (but not limited to) silicon and oxide, to form the embedded AR stack, the disclosure herein may achieve compatibility between materials with differing refractive indices—such as air, silicon, silicon nitride, and fused silica—reducing optical losses. The description herein not only enhances device performance by enhancing signal integrity but also provides the flexibility to tailor the embedded AR stack and/or AR coating for specific wavelengths or broader optical bands. The result may be a more robust, versatile solution that may accommodate future uses, including advanced photonic applications such as multiplexing and demultiplexing, polarization splitting/combining or beam shaping using meta-surfaces or embedded lenses.

Thus, this disclosure offers a versatile, high-performance optical device with both optical and electrical functionalities, useful for applications with low insertion loss, improved light redirection, and electrical interfacing, such as telecommunications, data center networking, and high-speed computing. Efficient optical epoxy-free hybrid or fusion bonding allows for integration within advanced PIC systems, improving performance, reliability, and scalability in demanding photonic applications.

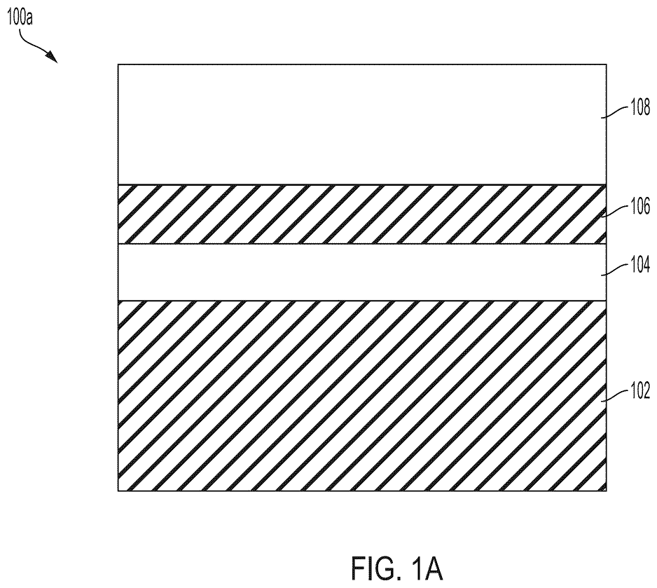

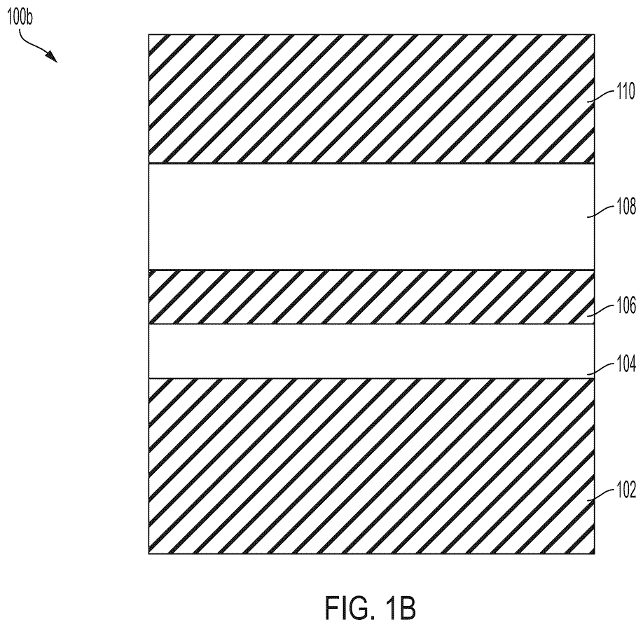

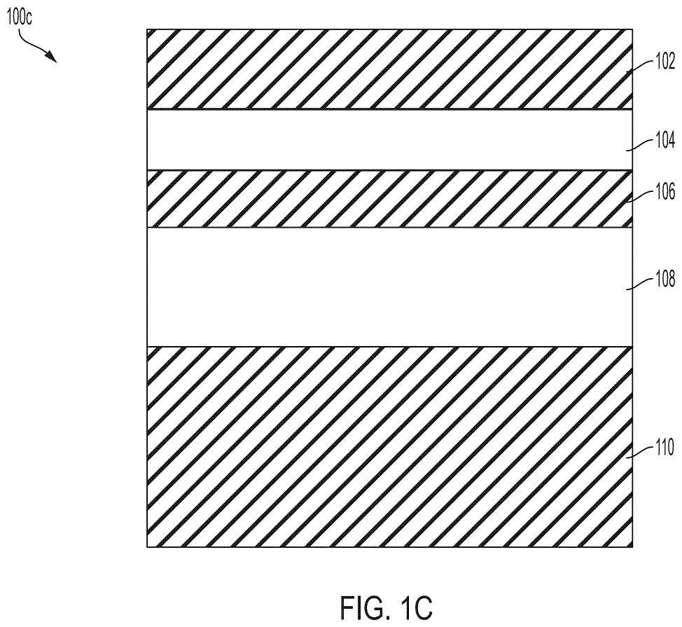

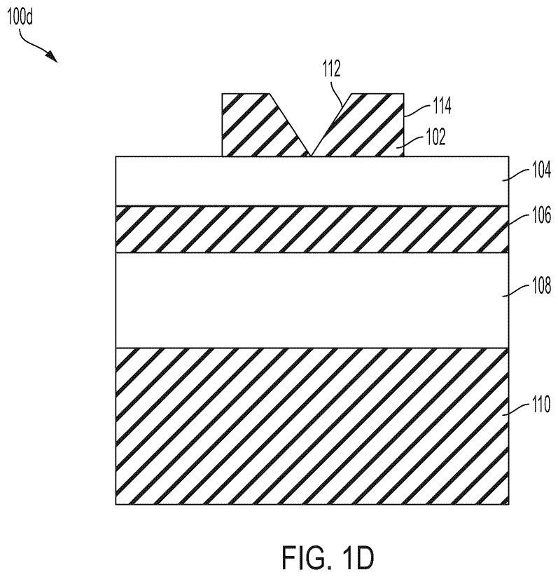

Referring now to FIGS. 1A-1D, FIGS. 1A-1D depicts a formation process or method for a silicon photonic device that may have an embedded AR stack and/or AR coating. FIG. 1A illustrates an initial structure silicon on insulator (SOI) 100a. SOI 100a may correspond to substrates used for silicon photonics. SOI 100a may include a silicon handle wafer 102, a buried oxide (BOX) layer 104, and a silicon layer 106. On top of this SOI structure, a second oxide layer 108 may be deposited and planarized. As shown in FIG. 1A, silicon layer 102 may be the base silicon substrate providing structural support for the entire stack in SOI 100a. Base silicon layer 102 may be advantageous for handling during the early stages of the process before the stack undergoes thinning. Base silicon layer 102 may include a thickness of substantially 700 μm. Silicon layer 102 may later provide the layer for forming a mirror and facet.

Above base silicon layer 102 may be BOX layer 104, which may be stacked underneath silicon layer 106. BOX layer 104 may include a thickness of substantially 0.01-1 μm. The BOX layer 104 may act as one of the layers in the embedded AR stack, which may function similar to AR coating. Silicon layer 106 may be a thin silicon layer on top of BOX layer 104. Silicon layer 106 may include a thickness of substantially 0.01-1 μm. Silicon layer 106 may form one of the layers of the embedded AR stack, because silicon layer 106 may interact with subsequent layers to help reduce reflection losses. As used herein, the embedded AR stack may be interchangeably be referred to as “layers 104, 106”. Layers 104, 106 may include one or more layers of silicon, oxide and/or other materials (e.g., nitride, tantalum oxide, and/or the like) that may have a differing refractive indices to form the AR layer pair.

Oxide layer 108 may include a thickness of greater than 3 μm, or substantially greater than 3 μm. Oxide layer 108 may be an additional oxide layer positioned, grown or deposited on top of the silicon layer 106, with a thickness exceeding 3 microns and polished flat. The role of oxide layer 108 may be to facilitate the bonding and subsequent inversion of the stack during the manufacturing process. Alternatively, the oxide layer 108 may be integrated onto the silicon carrier 110, planarized, then bonded to silicon layer 106, as an alternate means to create SOI 100b, as shown in FIG. 1B.

FIGS. 1B-1C correspond to planarization and bonding. In semiconductor and photonic device fabrication, planarization may be a manufacturing process used to smooth and level the surface of a material or wafer, for example. The goal of planarization may be to create a flat, uniform surface across the entire substrate, which may be advantageous for providing cohesive bonding and precise layering and patterning in subsequent fabrication steps. Planarization may help to remove surface irregularities such as bumps, dips, and variations in layer thickness that may arise during deposition, oxidation, or etching processes.

CMP may be one method of planarization which may involve both chemical and mechanical processes. A chemical slurry may be used to soften and chemically react with the surface material. A rotating polishing pad may be applied to the surface, using physical abrasion to remove excess material and smooth the surface. CMP may be used in semiconductor manufacturing to achieve a flat surface after deposition or etching of layers, so that subsequent layers may be applied without defects or variations. Alternative methods that achieve the same planarity and thickness may be used, such as, but not limited, those described below.

A liquid material (e.g., a dielectric or polymer) may be applied to the wafer surface, which may spread out evenly as the wafer spins at high speeds. After spinning, the liquid material may harden to form a smooth surface, helping to fill in gaps or uneven features created during previous operations. This technique may be used to planarize dielectric layers in integrated circuits or photonic devices (e.g., SOI 100a).

Using etch back planarization, a conformal layer of material may be deposited over any uneven surface in SOI 100b. Such surface may be etched back to a uniform level. This method may use material deposition and selective etching to achieve a flat surface but may not involve the mechanical abrasion seen in CMP.

In semiconductor and photonic device fabrication, layers of materials (e.g., layers 102-110) may be deposited sequentially on a wafer. Planarization provides that subsequent layers may be built on a flat surface, preventing defects in layer alignment or thickness. Uneven surfaces may cause performance issues in electronic and optical devices. For example, in photonic devices, uneven surfaces may lead to scattering, reflection losses, or interference, which may degrade the device's optical efficiency. Photolithography, a process in semiconductor manufacturing, may use flat surfaces for accurate pattern transfer. Without planarization, uneven surfaces may result in improper focusing or alignment of patterns. Thus, planarization may be an advantageous process in the fabrication of semiconductor and photonic devices, so that the surfaces may be smooth and flat, which may allow for accurate layer deposition, patterning, and optimal device performance.

In FIG. 1B, photonic structure 100b depicts when the silicon carrier wafer 110 has been added to the top via wafer-to-wafer bonding, preparing SOI 100b for inversion and further processing. Stated another way, silicon carrier 110 may be a temporary carrier wafer that may be bonded to the top oxide layer 108 and provide structural support during the inversion and backgrinding operations as well as further processing down the line. Silicon carrier 110 may provide stability and flatness as well as prevent damage to the underlying layers during the mechanical thinning process.

Oxide layer 108, with a thickness of more than 3 microns, may be added earlier (as shown in FIG. 1A) on top of the thin silicon layer 106. Oxide layer 108 may aid in supporting photonic structure 100b, 100c and provide a buffer between the silicon carrier 110 and the silicon layer 106 during processing.

FIG. 1C depicts photonic structure 100c, which may correspond to photonic structure 100b structure after an inversion operation. In FIG. 1C, SOI 100b has been flipped, or inverted, after bonding the silicon carrier 110 in FIG. 1B. The base silicon layer 102 may now be at the top, and such configuration may prepare the structure for backgrinding and CMP to achieve a specified height by design.

After the inversion, the silicon layer 102 may now serve as the layer for further processing into photonic elements, including optical components such as mirrors and the like. In this configuration, silicon carrier 102 layer may undergo thinning through backgrinding or CMP, reducing silicon layer 102 thickness from approximately 700 microns to 5-30 microns, as shown in FIG. 1C. After inversion, oxide layer 104 may remain between the silicon layers 102, 106. Oxide layer 104 may continue to facilitate part of the embedded AR stack.

Silicon layer 106 may now be positioned between the oxide layers (e.g., oxide 104 and oxide 108) and may serve as part of the AR stack. Once the thinning process is complete, silicon layer 106 may be revealed or, in other examples, may remain covered by a layer of oxide 108 to index match to fused silica (n˜1.5) or other structures with similar refractive index. A refractive index of silicon layer 106 may be optimized for minimizing reflection losses and maximizing light coupling efficiency in the photonic device (e.g., 100d). After inversion, oxide layer 108 may remain to act as a buffer and contribute to the overall performance of the embedded AR stack by providing the structural integrity of the bonded layers and protection of the embedded AR stack formed by layers 104, 106.

As shown in FIG. 1D, once SOI 100c is created, optical components including mirror 112 and/or facet 114 may be created to form SOI 100d. For example, after photonic structure 100c is thinned, an etching process may be used to create a mirror surface (mirror 112) on what is now the top side of photonic structure 100d. Mirror 112 may be advantageous for reflecting light in a photonic device. After such etching, a high-reflective (HR) coating may be applied to mirror 112 or use of TIR may also be possible. Similarly, an AR coating may be applied to facet 114, so that light may be properly guided with minimal reflection loss.

Facet 114 may correspond to a cavity etched to form the facet, which may guide the light into the photonic device. Facet 114 may be advantageous in providing proper light alignment and minimizing losses. For clarity, a brief review follows. In the context of photonic integrated circuits (PICs), a facet may refer to a precisely angled surface that may be designed and etched into the silicon or another semiconductor material to facilitate efficient light coupling between the components of the photonic system, such as waveguides or optical fibers. The facet's function may be to control how light enters, exits, or is redirected within the photonic circuit to minimize reflection losses and optimize signal transmission.

For example, waveguides in PICs may be the optical equivalents of electrical wires, designed to guide light through the chip. However, transferring light between different media, for example, from the PIC waveguide to an optical fiber, may not be as simple as with electrical conductors due to reflection, scattering, and alignment issues. Thus, a facet may act as the interface between the waveguide and the optical fiber, directing the light into the fiber at an optimal angle and ensuring that the transition is efficient and low-loss. The facet angle may be advantageous for proper alignment with the optical fiber to avoid significant signal degradation as well as preventing propagation of back-reflected light. Moreover, when light encounters a surface transition between different materials (e.g., silicon in a waveguide and air or glass in an optical fiber), such light can reflect, scatter, or even refract undesirably, leading to optical losses.

Accordingly, facet 114 may provide a surface that may be coated with anti-reflective (AR) coatings, which may help reduce reflections at the interface and ensure maximum transmission of light between the PIC and external optical components. This may be advantageous in applications like data communication, where even minimal losses may affect performance.

The facets may be angled or tilted to guide light at specific angles to minimize reflection back into the waveguide, which may cause interference or signal degradation. The facet angle and surface smoothness may directly influence the coupling efficiency, determining how much light may be transmitted between the PIC and external components. For example, an 8° facet may be utilized. Facets with more or less than 8° may be used (e.g., 4°-12°). Such facets may be configured using high precision, advanced techniques including wet etching or DRIE.

Facets may also be used to create mirrors or reflective surfaces within the photonic device or PIC, redirecting light back into the circuit or towards another optical element. For example, a facet may reflect light from one waveguide into another or into a detector or another photonic element, depending on the design. These reflective facets may be coated with high-reflectivity (HR) materials to enhance the reflection or use total internal reflection (TIR), so that the light may follow a specific propagation path without significant losses.

A facet may include one or more of: coupling facets, cleaved total internal reflection (TIR) facets, diffraction grating facets, blazed facets, tapered facets, angled polished facets (i.e., mirror 112), transmissive facets, absorptive facets, phase-shifting facets, hybrid facets, or the like. For example, facet 114 may include coupling facets used for efficient light transmission between waveguides and/or optical fibers and other optical elements, such as mirrors and lenses. A facet may include: cleaved facets which may be created by mechanically cleaving a crystal to provide a smooth, angled surface, total internal reflection (TIR) facets that guide light using the principle of total internal reflection, diffraction grating facets that separate light based on wavelength, and blazed facets where grooves may be angled to direct light. Additionally, tapered facets may be used to gradually adjust the mode profile of light between components, angled polished facets may reduce unwanted reflections by using a non-perpendicular surface, absorptive facets may be designed to absorb stray light to minimize interference, phase-shifting facets may introduce controlled phase shifts for precise light manipulation, and hybrid facets may combine multiple optical functionalities such as reflection and diffraction into one design. Facet creation may involve etching techniques, such as wet etching or Deep Reactive Ion Etching (DRIE), to define mirror surface 112 or facet 114.

In practical applications, PICs may couple light to external devices like optical fibers, lasers, or detectors. Facets may provide a precisely angled exit point for light to efficiently interface with these components, providing minimal loss when transitioning between the PIC's internal waveguides and external optical systems. Proper alignment between the facet and the external component may be advantageous for maintaining signal integrity in high-speed optical communications where small misalignments may cause significant performance degradation.

For example, in optical transceivers used for fiber-optic communications, facets may facilitate the efficient coupling of light from the photonic chip's waveguides into the optical fiber, enabling high-speed data transmission with minimal losses. PICs may be used in data centers for handling large volumes of optical signals. Facets may be advantageous in coupling light between chips and external optical networks or devices to ensure the efficient and reliable transmission of data. In integrated optical sensors, facets may be used to couple light into the sensor and direct the reflected or transmitted light into a detector for analysis. Precision facets may ensure that the light paths are well controlled for accurate sensing.

The embedded AR stack (i.e., oxide layer 104, silicon layer 106 or multiples thereof), embedded within device 100d, may minimize light reflection and improve the overall structure's (e.g., SOI 100d) light coupling, thereby improving optical coupling and overall device performance, which may be advantageous where there is an index of refraction mismatch. By embedding the AR stack via oxide layer 104, silicon layer 106, reflection losses may be minimized after thinning and inversion, resulting in superior optical performance. The ability to bond and invert SOI structure 100c while maintaining precise control over layer thickness and material placement may allow for flexibility in photonic device design, including tailoring the embedded AR stack and/or AR coatings for specific wavelengths.

The combination of wafer bonding, inversion, backgrinding, and facet creation may provide a robust, scalable solution for producing high-performance photonic devices with the embedded AR stack and/or AR coating. This process may enhance photonic device efficiency by providing an advanced method for managing reflection losses and improving light coupling across different materials, suitable for telecommunications and data center networking systems.

The angle of the facet may be advantageously chosen based on the refractive indices of the materials involved and the application. Such angles may range between 8° and 55°, where the choice may be dependent on whether a mirror facet (e.g., 35°-55°) or a coupling facet (e.g., 4°-12°) is formed. Wet etching or DRIE may be used to create facets in semiconductors with high precision. These processes provide facets that may be smooth and well-defined, reducing scattering and other forms of optical loss. Applying AR coatings to coupling facets may be advantageous for reducing Fresnel reflection at the interface between materials with differing refractive indices, further enhancing the coupling efficiency. After thinning and etching, photonic structure 100d may be ready for integration into a photonic device or PIC.

For clarity, the coupling facet, which may be associated with the vertical cutout, may prevent back reflection of light that may propagate through the device and cause signal interference. Unlike facets that may be dependent on crystal orientation, the coupling facet's angle may be adjusted to minimize reflection. A minimum angle may be chosen for this purpose to be substantially 8° or to be substantially 0°, or this may vary depending on the specific optics of the PIC device. Such coupling facet's angle may be frequently achieved by adjusting the waveguide exiting the facet rather than modifying the facet itself, although both approaches may be used for providing efficient light transmission. DRIE may be advantageous for creating this coupling facet, because DRIE may offer the precision for controlling the angle without being constrained by the crystal structure of the material.

In contrast, the mirror facet may rely on the crystal orientation of the material because such mirror may be formed using a wet etching process. In such cases, the angle of the mirror facet may be advantageously influenced by the underlying crystal planes of the silicon or other semiconductor material. Thus, wet etching may be advantageous for creating the angled mirror surface used for redirecting light within the photonic device, where the crystal orientation may directly determine the facet angle. The mirror facet angle may range from 8° to 55°, selected based on the refractive indices of the materials involved and the specific application. An advantageous selection of the mirror facet angle may provide optimal light redirection and reflection efficiency in the photonic device's design, making such angle an advantageous factor in maximizing optical performance. Angle may be determined through the initial seed growth of the ingot to form the wafer with the crystalline orientation of the silicon being <100>, <111>, <311>, <511>, etc. or through off-axis dicing of these wafers. Subsequent wet etching will then etch along the crystalline plane to form a precise angle.

Alternatively, or in addition, a mirror facet may rely on advance processing techniques, such as gray scale lithography, to create a precise slope with the correct angle for various applications. Another option is to use imprint lithography and/or transfer etching to form the correct structure. Other such advanced processes may be utilized to form the final structure and depend on capabilities available.

By using both DRIE for the coupling facet and wet etching or other advanced processes for the mirror facet, creating precision optical interfaces that meet the varying demands of photonic device applications may be provided. The combination of DRIE and wet etching, or similar advanced processes, may allow for greater control over light propagation, reducing interference while optimizing reflection and redirection of light across the device's embedded AR stack. This combined approach may enhance the device's overall efficiency and adaptability for high-performance optical and photonic systems.

Additionally, the surfaces remaining above oxide 104 and/or silicon 102 can be used for precision mechanical elements to ensure correct height placement when integrating in a PIC. For example, if oxide 104 is used as the precise mechanical vertical height position, a process of fusion or hybrid bonding can ensure reliable integration with very small deviations in height tolerances. This can be helpful when the optical path uses sub-micron or few-micron precision to get optimal light propagation. Alternatively, the surface of silicon 102 can be a vertical mechanical positioner, where non-optical adhesives that have been used for multiple solder reflow cycles can be incorporated in the remaining space between the PIC and oxide 104 without affecting the optical path.

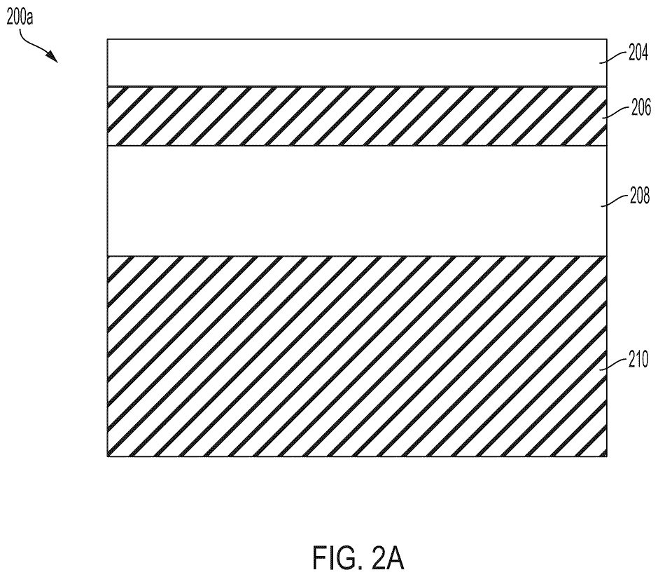

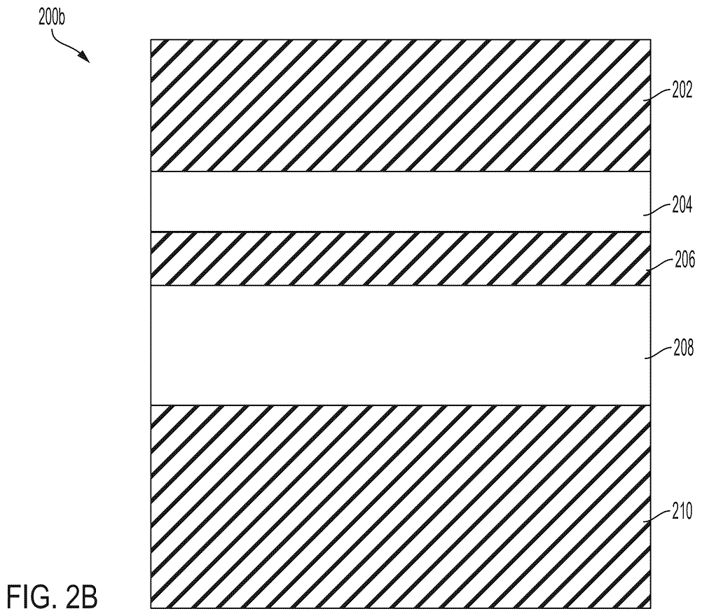

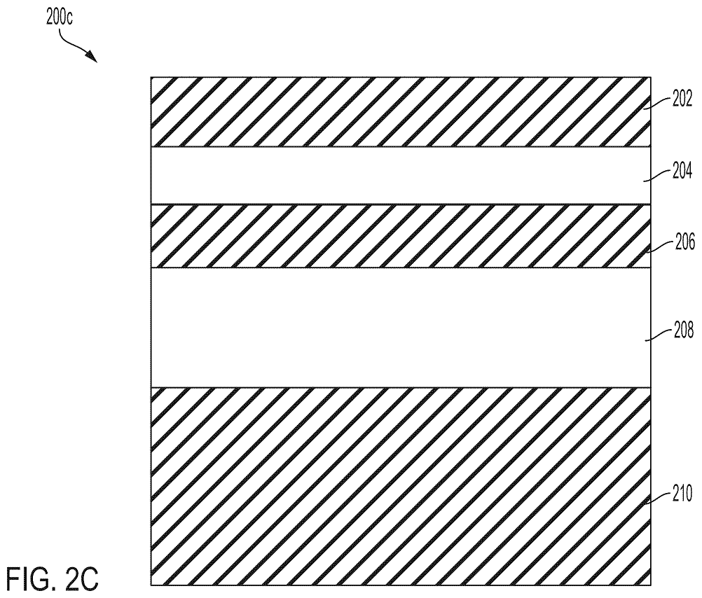

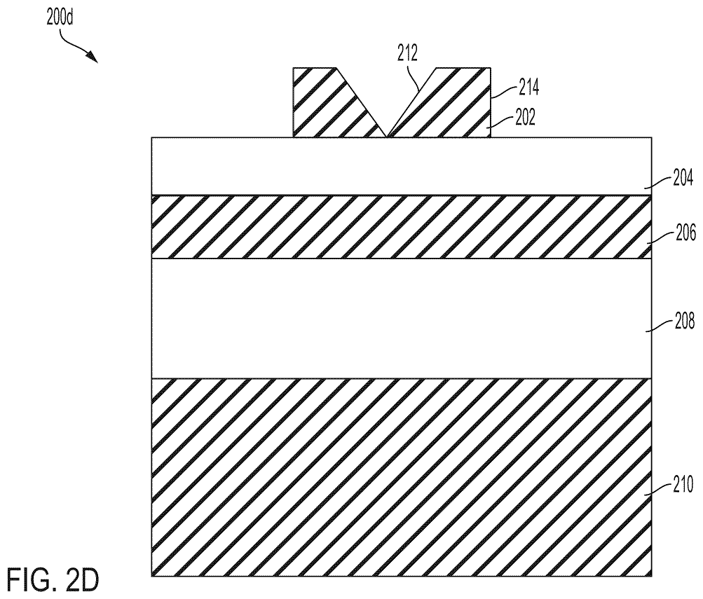

FIG. 2A-2D depict the progressive steps in creating a photonic device with an embedded AR stack, focusing on building up the structure layer by layer and preparing the photonic device for optical functionality. FIG. 2A shows an initial stack SOI 200a. SOI 200a construction may differ from the initial SOI 100a, having an inverse order in buildup of the stack. The thicknesses of such layers may be advantageously controlled so that the structure meets design standards for insulation and optical performance.

For example, silicon layer 210 may be the base silicon layer, approximately 700 microns thick, and may serve as the foundational material of the structure. Oxide layer 208 may include a thickness greater than or substantially greater than 1 μm. Oxide layer 208 may be a slightly thicker layer intended to protect the embedded AR stack (formed by silicon layer 206 and oxide layer 204) and may be placed on top of the base silicon 210. Oxide layer 208 may help manage refractive index differences similar to, or the same as, oxide layer 108 in 100a. Silicon layer 206 may include a thickness between substantially 0.01-1 μm. Silicon layer 206 may form part of the embedded AR stack, which may minimize reflection losses as light transitions between different materials. Oxide layer 204 may include a thickness in the range of 0.01-1 μm. Oxide layer 204 may be thinner than the oxide layer 208 (or 108 in 100a) and may be used to form the embedded AR stack similar to, or the same as, oxide layer 104 in 100a.

FIG. 2B shows stack 200b after the bonding of a silicon wafer 202 on top of the oxide layer 204 to provide the layer used for creating photonic structures such as facets 212, 214 (as illustrated in FIG. 2D). Silicon layer 202 may form the top of the structure and allow for efficient optical coupling. Silicon layer 202 may be added through wafer-to-wafer bonding and ready for backgrinding or thinning and polishing. In later stages, silicon layer 202 may be thinned down to achieve the selected thickness for the final photonic device. For example, backgrinding may thin down the silicon carrier to around 5-20 microns, preparing silicon layer 202 for facet creation. Oxide layer 204 may be added to silicon 202 prior to bonding to silicon 206 as an alternate integration process.

Oxide layer 208 may remain intact through the process, serving to protect the embedded AR stack (formed by silicon layer 206 and oxide layer 204 or “layers 204, 206”) and aid in maintaining the overall integrity of the structure during subsequent processing operations. Layers 204, 206 may stay as part of the core structure, forming part of the embedded AR stack that may act to reduce reflection losses. Multiple instances of layers 204, 206 may be used to form the embedded AR stack depending on the application. Additionally, these materials are just exemplary materials and may be any contrasting pair of refractive index materials compliant with semiconductor processing.

As shown in FIG. 2C, in SOI 200c, the top silicon layer 202 may be thinned down to approximately or substantially 5-30 microns in subsequent processing operations. Silicon layer 202 may be the working surface for further etching, facet creation, and AR coating application. Oxide layers 208, 204 and silicon layer 206 may contribute to the overall refractive index matching used for the photonic device's operation. These layers may not be removed during the backgrinding process but may instead help form the final structure with minimal optical losses. Oxide layer 208 may be partially removed or fully removed as its intent may be to index match with another structure of the same refractive index, thus its final thickness may protect the precise thickness of the silicon layer 206 during further processing operations.

In FIG. 2D, the final structure SOI 200d prior to integrating with a PIC may include the creation of the facets and the application of AR coating, ready for integration into a photonic system. Etched facet 214 may be created through processes like greyscale or imprint lithography and transfer etching, wet etching along crystalline axes, or DRIE. Mirror 212 may include an angled surface. Such angled surface may be advantageous for creating reflective surfaces to redirect the light via total internal reflection (TIR) or by adding a high-reflective (HR) coating. As described previously, the angle may be 8°-55° depending on the application. The angle may be formed via advanced fabrication techniques like greyscale lithography or imprint lithography and transfer etching or via wet etching along crystalline planes. The crystalline plane may be determined through the original seed crystal orientation, such as <100>, <111>, <311>, <511>, etc. and/or through off-axis dicing of the ingot.

AR coating may be applied to facet 214. Application of AR coating to facet 214 may efficiently couple light into and out of the photonic device with minimal reflection loss, optimizing the overall optical performance. AR coating may be configured to match the refractive index of materials like silicon, silicon nitride, air, or fused silica, depending on the application.

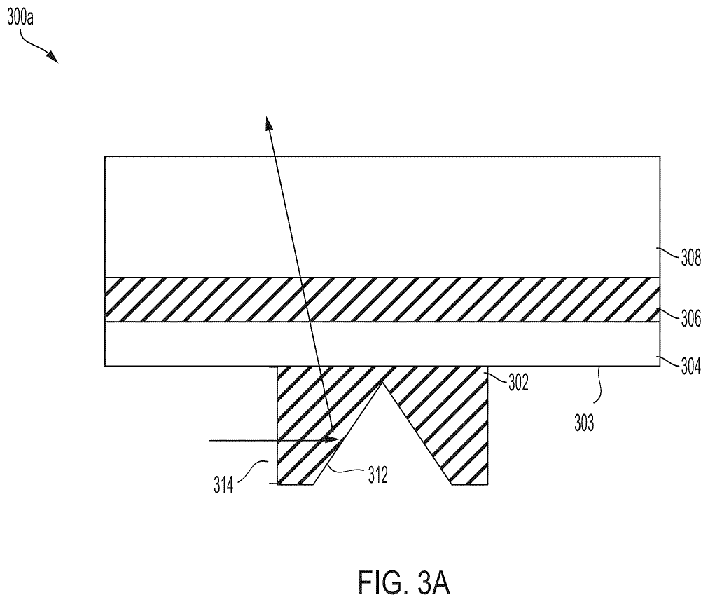

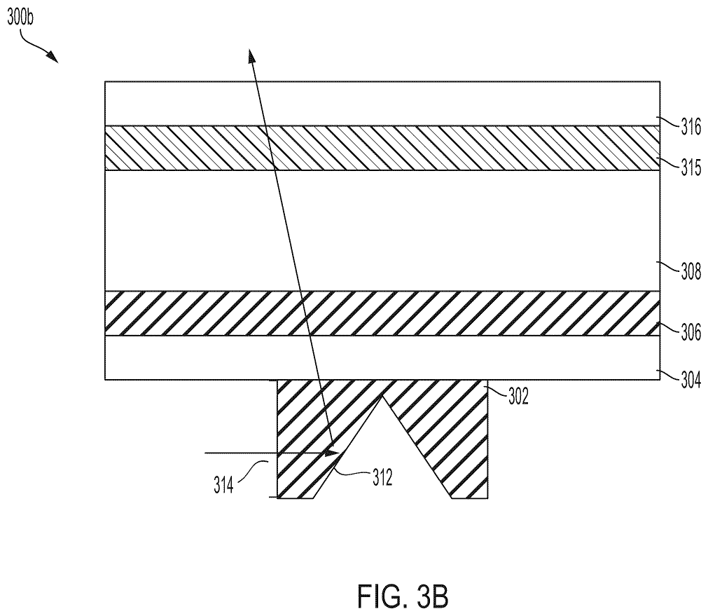

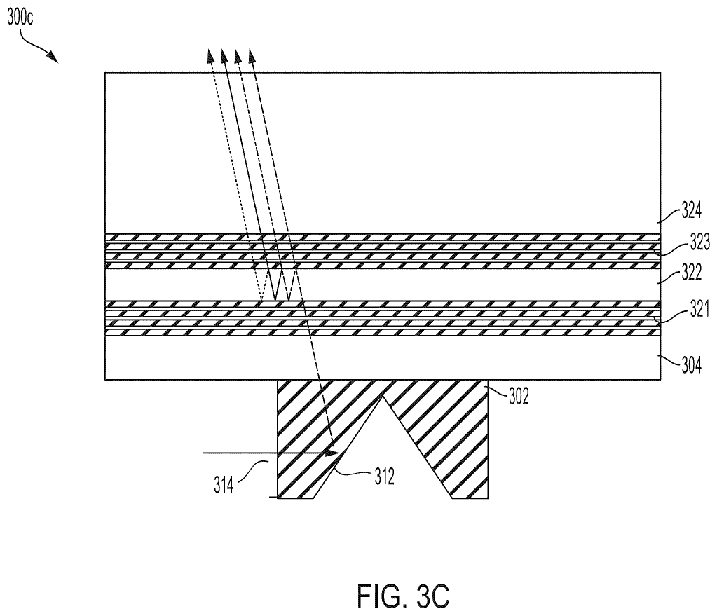

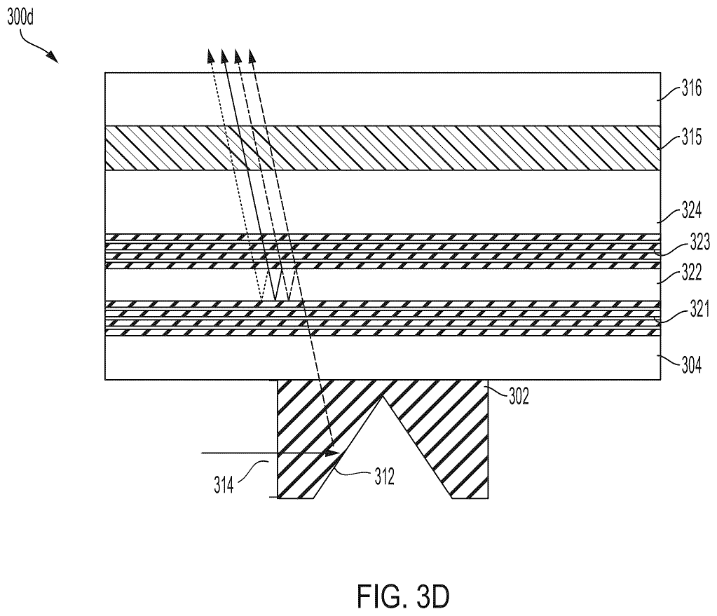

FIG. 3A depicts a photonic device 300a (“device 300a”). Device 300a may encompass a photonic structure with an embedded anti-reflective (AR) stack formed by oxide layer 304 and silicon layer 306, a facet 314 for light coupling, and a mirror facet 312 to redirect the light. Device 300a may be constructed using layer growth, wafer bonding, inversion, backgrinding, facet creation, HR and/or AR coating deposition as described in FIGS. 1A-1D and 2A-2D. This figure shows how the light path may be enabled once the device 300a is embedded into a cavity within a PIC such that the waveguide of the PIC may align to the optical elements, such as the facet 314 and mirror facet 312 of device 300a.

Additionally, to the light path, surface 303 may be used as a mechanical stop to enable precise alignment in the vertical axis, which is not achievable by standard alignment methodologies like alignment markers. Thus, by incorporating alignment markers and this mechanical stop, we can get precise placement in all axes. The bottom surface of body 302 may also be similarly used for a mechanical stop element.

Oxide layer 308 may include a refractive index of substantially 1.5. Oxide layer 308 may be advantageous for refractive index matching, providing that the light experiences minimal reflection when transitioning from the silicon layer 302 to the external environment (e.g., optical mediums like air, glass, and the like). Oxide layer 308 may serve as a buffer to provide smooth propagation of light between the photonic device and other mating devices.

Beneath the oxide layer 308 may be a thin silicon layer 306. This thin silicon layer 306 may play an advantageous role in the embedded AR stack, which may be bonded, deposited or grown on oxide layer 304 during earlier stages of the fabrication process. Silicon layer 306 may minimize optical losses by matching refractive indices across photonic device 300a. Oxide layer 304 may serve as another layer of the embedded AR stack and may minimize optical losses. Silicon layer 302 may provide a platform for further processing, such as facet etching and AR coating and/or HR coating application.

Mirror facet 312 may be created at a specific angle, for example, substantially 54.7°, based on the properties of <100> silicon. Alternative angles between 35°-55° may be used for the mirror facet 312, depending on the etching process, initial wafer crystal orientation or off-axis cutting of the ingot, and application. Such angle may facilitate efficient reflection of light into the external environment.

The AR coating may be applied to the facet 314 to reduce reflection losses when light exits or enters the photonic device. The AR coating may include a series of layers designed to match the refractive index of the materials on either side of the interface (e.g., air, glass, silicon-nitride or silicon). The goal of the AR coating may be to improve optical coupling efficiency by minimizing the reflection that may occur at the interface between materials with different refractive indices.

Etching of the facet may include a wet etching process that may be used to create the mirror facet 312 in silicon. Silicon may have a defined etch plane, particularly when using the common <100> silicon orientation. Such orientation may result in a facet angle of 54.7°. However, this angle may not be ideal due to potential issues with dispersion and angle of incidence for light coupling.

To overcome the limitations of the 54.7° angle, the silicon may be cut at a bias angle during the ingot slicing process or grown for alternative crystal orientations such as <111>, <311>, or 511. This may allow for the creation of facets with angles ranging from 35° to 55°, providing greater freedom in designing the photonic structure. Doing so may be advantageous because the angle of the facet may have an impact on how light is reflected or refracted within the photonic device 300a. Alternatively, using advanced lithography processes such as greyscale or imprint and transfer etching can enable various angles as per design.

The silicon (e.g., silicon layer 302) used during earlier stages of the method as described above may be a standard <100> silicon or a bias-cut silicon ingot. The choice of orientation may affect the etch angle if using the wet etching process. After backgrinding to the 5-30 μm nominal design thickness, the facet may be etched into the final silicon structure. The use of a bias-cut ingot may allow more control over the final facet angle, which may be advantageous for applications using precise light coupling angles.

One of the advantages in the examples described above may be achieving advantageous oxide and silicon thicknesses (e.g., oxide layer 304 and silicon layer 306). For example, for larger wafers, oxide layers may be bonded, grown, or deposited to a maximum of 3 microns. However, smaller wafers or chiplets may provide more freedom to experiment with larger oxide thicknesses, which may be used to achieve better optical performance in certain photonic designs.

Thus, there may be advantages with using smaller wafers or chiplets during the fabrication process. Smaller wafers may offer more flexibility in terms of oxide layer thickness and etch angle control, making smaller chiplets suitable for advanced or experimental photonic designs that later may drive larger wafer scale improvements. Chiplets may allow for pushing the boundaries of conventional oxide deposition techniques, allowing for the use of thicker oxides or more complex multi-layered structures.

There are also advantageous reasons to use wafer sizes equivalent to the PIC wafer size where device 300a would get integrated in order to enable wafer-to-wafer fusion or hybrid bonding to establish high-volume and high-throughput processes.

The embedded AR stack may be enabled by precision thicknesses of the stack layers (e.g., oxide layer 304, silicon layer 306), which may help match the refractive index differences between silicon (n≈3) from silicon layer 302 and other materials like air (n≈1) or glass (n≈1.5) represented by oxide layer 308. Thus, by controlling the angle and quality of the facet surface, PIC designers may minimize reflection losses and optimize device 300a for high-performance optical transmission.

For AR coating facets in device 300a, ultra-thin layers with varying refractive indices using materials such as SiO₂, Si₃N₄, TiO₂, and MgF₂ may be advantageous for optimizing light transmission and minimizing reflection losses. These materials may be deposited using advanced techniques like PECVD, ALD, and electron beam evaporation to form multilayer AR coatings that may improve optical performance in the PIC devices.

Such AR coating may include silicon dioxide (SiO₂) having refractive index: ˜1.46, which may be used as a low-refractive index material in AR coatings to minimize reflections. Silicon dioxide may provide good optical transparency and thermal stability and may be embedded utilizing chemical vapor deposition (CVD), plasma enhanced chemical vapor deposition (PECVD), thermal oxidation (for native SiO₂ on silicon substrates), or other such techniques.

Such AR coating may include silicon (Si) having refractive index: ˜3, which may be used as a high-refractive index material in AR coatings to minimize reflections. Silicon may provide good optical transparency and thermal stability and may be embedded through wafer-to-wafer bonding, deposition, or other techniques. Si may be paired with SiO₂ in multilayer coatings.

Such AR coating may include silicon nitride (Si₃N₄) having a refractive index ˜2.0. Silicon nitride as an AR coating may include high optical transmission in the visible and infrared spectrum. Silicon nitride may be paired with silicon dioxide in multilayer coatings. For example, embedding may be performed using PECVD or low pressure chemical vapor deposition (LPCVD).

AR coating may include titanium dioxide (TiO₂) having a refractive index of ˜2.4. Titanium dioxide may provide a higher refractive index, and may be used in multilayer AR coatings to increase light transmission by constructive and destructive interference. Titanium dioxide may be used in advanced photonic devices for better control over light propagation. Embedding TiO2 may be performed using sputtering, electron beam evaporation, and/or atomic layer deposition (ALD). AR coating may include zinc sulfide (ZnS) having refractive index of ˜2.35. ZnS may be used in AR coatings for applications that have transmission in the visible and infrared ranges.

AR coating may include aluminum oxide (Al₂O₃) having a refractive index of ˜1.7. Aluminum oxide, also known as alumina, may be used as an intermediate index material in multilayer AR coatings. Aluminum oxide may offer good optical properties and robustness. AR coating may include magnesium fluoride (MgF₂) having a refractive index of ˜1.38. MgF₂ may be a low-refractive index material used in AR coatings for its transparency in the ultraviolet, visible, and infrared spectrum. MgF₂ may be advantageous as a final top layer in AR coatings. AR coatings may include hafnium oxide (HfO₂) having a refractive index of ˜2.0. HfO₂ may be used for its high refractive index and transparency in the visible and infrared regions. Alternative materials may also be used such as tantalum oxide and the like. This list of possible materials should not be construed as exhaustive, but merely exemplary.

Such ultra-thin AR coating layers may be deposited using the following methods: chemical vapor deposition (CVD), plasma enhanced chemical vapor deposition (PECVD), atomic layer deposition (ALD), sputtering, electron beam evaporation, and/or thermal evaporation. A brief overview follows.

CVD may be a process in which precursor gases may react on the substrate surface, forming a solid material layer. CVD may allow precise control over thickness and uniformity, making it useful for multilayer coatings. CVD may be used for materials like SiO₂ and Si₃N₄. PECVD may be used for depositing dielectric materials such as SiO₂, Si₃N₄, and TiO₂. PECVD may be a variation of CVD in which plasma may be used to enhance the chemical reaction, allowing for lower deposition temperatures. ALD may be a method that deposits thin films one atomic layer at a time, resulting in highly conformal and precise coatings. ALD may be used for high-performance optical coatings with excellent thickness control. Sputtering may be a physical vapor deposition technique in which ions bombard a target material, causing atoms to be ejected and deposited onto the substrate. Sputtering may be ideal for high-density films. Electron beam evaporation may be a type of physical vapor deposition in which an electron beam may be used to heat a material, causing such material to evaporate and condense on the substrate. This method may be highly efficient for producing high-quality thin films. Thermal evaporation may be a physical vapor deposition method in which the material may be heated in a vacuum until such material evaporates and forms a thin film on the substrate. It may be used for depositing low-refractive index materials like MgF₂ and may be used for producing uniform AR coatings for photonic devices.

Accordingly, photonic device 300a may be a highly optimized structure for light coupling in optical applications. The combination of precise etching, control over the facet angle (through bias-cut silicon or alternative methods), and the application of a multi-layered AR coating may provide that the device performs with minimal reflection losses. The detailed process flow, from layer deposition and inversion to etching and coating, demonstrates the advanced techniques involved in creating high-performance photonic devices suitable for telecommunications, data center networking, or other optical applications.

Modifying the thicknesses of the dielectric layers may be advantageous for tailoring the AR coating to specific wavelengths. For example, with two layers, the AR coating may target the 1310 nm wavelength used in optical communications, ensuring compliance with industry standards like Institute of Electrical and Electronics Engineers (IEEE) 100BASE-DR. The number of AR coating layers may be increased to broaden the wavelength range (broader band AR coatings).

Additional structures may also be embedded during creation of the device 300a or through post processing integration after being embedded into the PIC. Additional structures may include meta-surfaces or embedded lenses with patterns or materials to induce light shaping in advantageous ways, such as collimation of the light to enable further optical devices to integrate with lower loss or high alignment tolerances as shown in FIG. 3B. Device 300b may include a silicon layer 302, an oxide layer 304, a silicon layer 306, an oxide layer 308, mirror facet 312, a meta surface 315, and a protective oxide layer 316. Meta surface 315 may be used instead of AR or in addition to AR to shape and/or manipulate light along the path. Meta surfaces can also enable beam shaping (e.g. collimation), beam splitting/combining, polarization splitting/combining, wavelength splitting/combining and such. There can be more than one layer of meta-surfaces or similar incorporated to enable the final structure enabling one or more changes on the light. The benefits of meta surfaces are such that alignment may potentially not be required because the resulting light propagation path may be dependent on the light phase entering the meta surface and not in specific structures of the meta surface being aligned to the device.

Alternatively or in addition, the number of layers may be leveraged to form mirrors instead of anti-reflection coatings and to separate wavelengths physically in space for applications like multiplexing and demultiplexing as shown in FIG. 3C. Device 300c may include a silicon layer 302, an oxide layer 304, a mirror facet 312, stacked dielectric 321, 323, oxide layer 322, and oxide layer 324. The stacked dielectrics 321, 323 and mirror openings may allow for wavelength multiplexing and demultiplexing that may be polarization insensitive. Alternatively or in addition, these layer structures can be polarization sensitive and allow for polarization splitting of the light. This can be advantageous to enable PIC structures to incorporate TE designs that are much easier to design and lower loss for optical coupling and a very compact form factor. The direction of the splitting/combining may be designed based on the final application and not limited to the depiction shown in FIG. 3C.

These elements may be combined in various ways to enable various functionalities that are broadband, polarization insensitive, and compact as shown in the example FIG. 3D. Device 300d may include silicon layer 302, oxide layer 304, stacked dielectric 321, 323, oxide layer 322, oxide layer 324, mirror facet 312, meta-surface 315, and oxide layer 316.

By embedding these elements (e.g., metasurfaces, micro-lenses, stacked dielectrics) within the structure, they may remain functional even after backgrinding and thinning, leading to more efficient optical performance and the potential for broader applications in photonic devices and integration methods used to incorporate in hybrid packages.

In FIGS. 3A-3D, after creation of the mirror facet 312, an oxide deposition step may be used to fill the cavity such that the mirror surface may remain planar and flat for further processing. Oxide deposition may be after an HR coating is applied to mirror facet 312 when total internal reflection (TIR) is insufficient with the facet angle designed. Opening up facet 314 via DRIE or similar etching and applying AR coating for best transmission may follow. Material that remains at the base of the structure may be removed through highly selective etching processes, such as TMAH or similar, to enable a smooth and defect-free surface (e.g., surface 303) for hybrid or fusion bonding to the PIC. This surface can also be enabled to bond via new integration methods being explored with polymer or other materials instead of direct oxide-to-oxide hybrid or fusion bonding techniques that are susceptible to surface imperfections.

Having a remaining surface available for hybrid or fusion bonding provides a reliable interface that can utilize advanced processing with tight alignment capabilities, such as <0.5 um. These capabilities are advantageous to further improve the optical performance and low loss optical signals. Additionally, these processes are compliant then to standards that are often used in semiconductor manufacturing that prove highly reliable and high yielding performance, such as standards supported by the Joint Electronic Devices Engineering Council (JEDEC). This capability is in contrast to integration methods for optical components that rely in index matching epoxies that can degrade of large temperature cycling or long exposure to high power optical sources, both impacting yield and reliability of the final components.

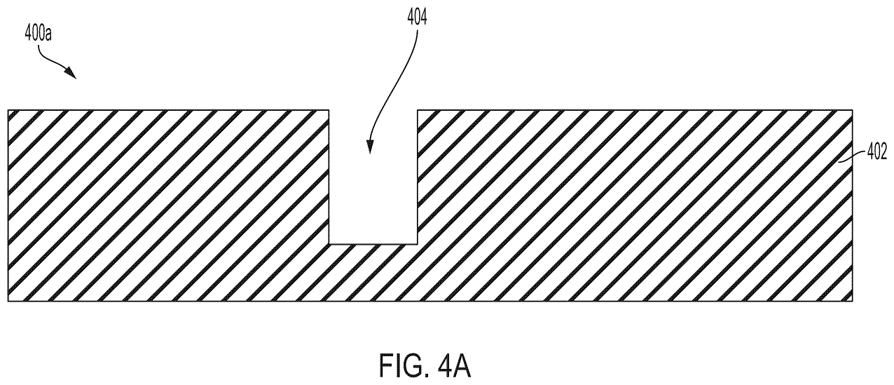

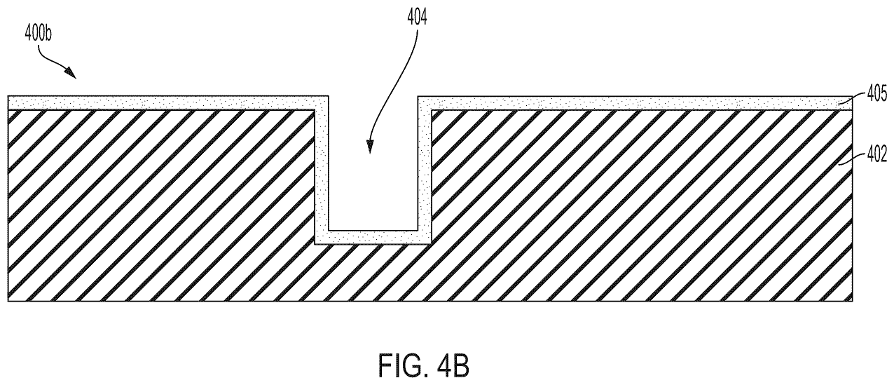

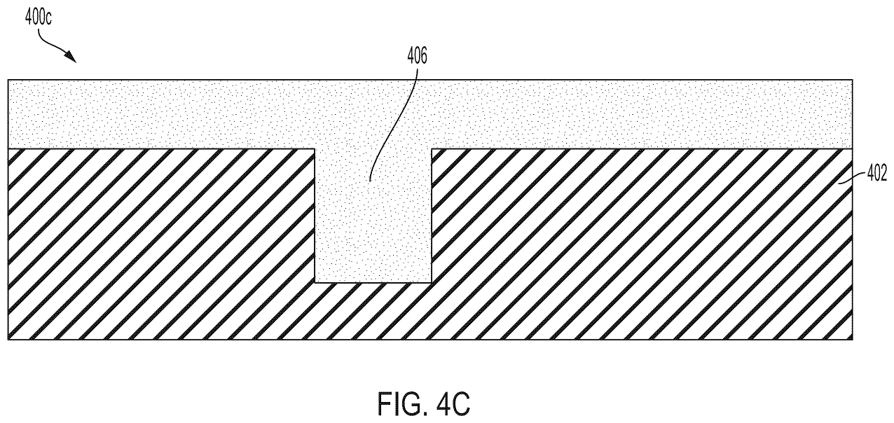

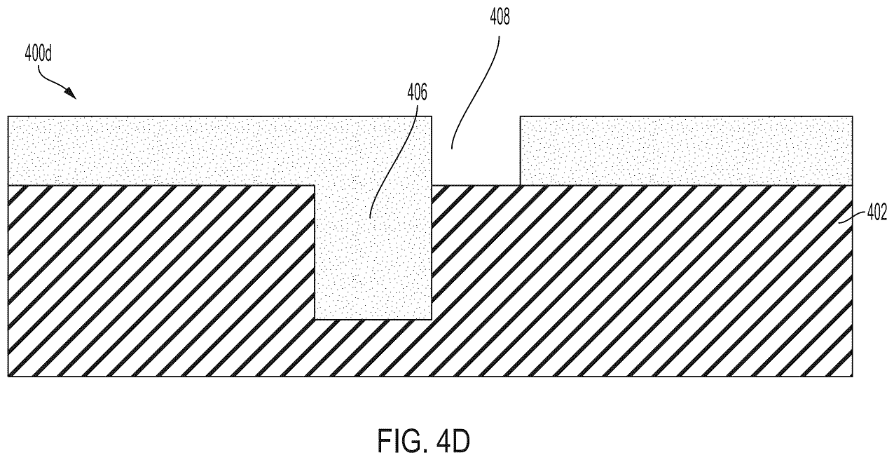

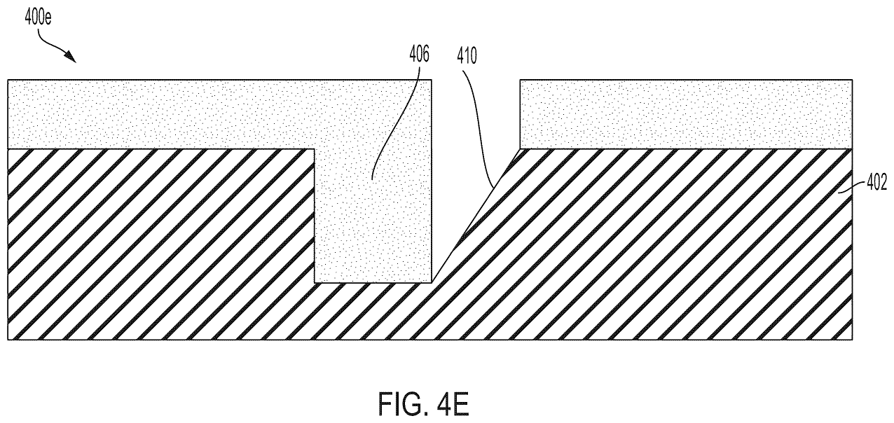

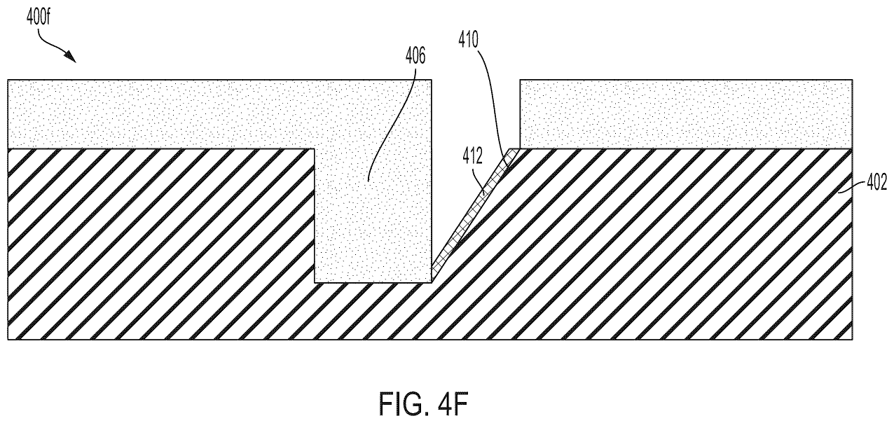

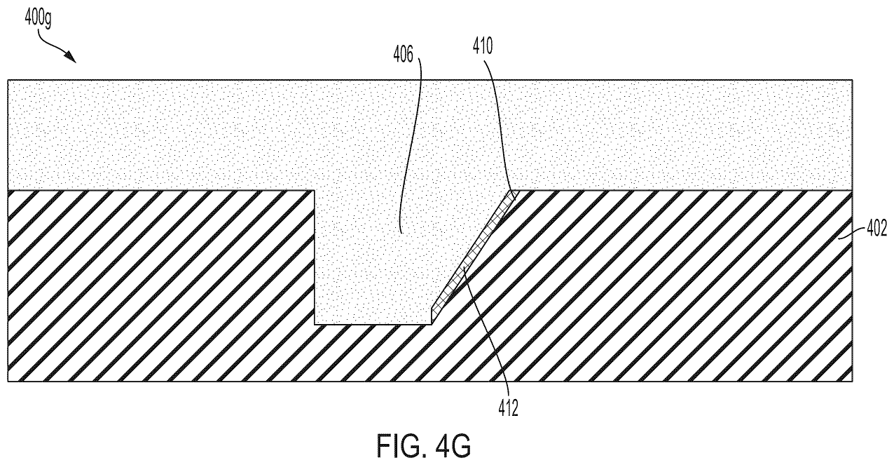

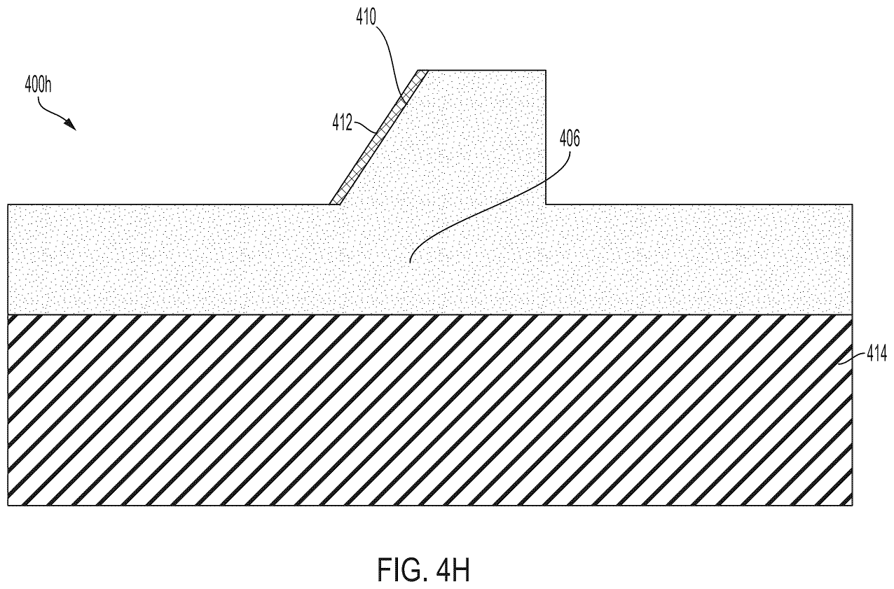

FIGS. 4A-4H depict a formation process for a silicon photonic device that can subsequently enable optical epoxy-free hybrid or fusion bonding to a PIC, similar to FIGS. 1-3, but created in an alternate method without embedding optical elements such as AR, meta-surfaces and mux/demux layers since the light will propagate away from the device once embedded into the PIC (rather than into the device as shown in the earlier examples). FIGS. 4A and 4B may correspond to the initial stages of forming an optical structure on a silicon wafer substrate, which may subsequently facilitate hybrid bonding in a PIC. As shown in FIGS. 4A-4B, such formation process may include an optical structure 400a. A silicon wafer 402 may serve as the substrate for creating the optical structure. Silicon wafer 402 may serve as the platform for subsequent etching, growth, deposition, or bonding operations. Silicon wafer 402 may be of standard orientation (i.e., <100>), alternate orientations (e.g. <111>, <311>, <511>, etc) or silicon wafer 402 may be bias cut to facilitate creation of specific facet angles in the 35-55° range through wet etching processes. Alternatively, different angles may be created via advanced lithography techniques, such as greyscale or imprint lithography and transfer etching.

As shown in FIG. 4A, an etching process may be performed to form a cavity 404 within silicon wafer 402. Cavity 404 may subsequently house an optical structure (e.g., a mirror), which may play an advantageous role in directing or reshaping light within the PIC. Cavity 404 may be created through a deep reactive ion etching (DRIE) process. DRIE may allow for precise control over the shape and depth of the cavity, producing vertical (>80°) facets that may be advantageous for aligning the optical structure with the waveguide. The facets formed by DRIE etching may facilitate efficient light coupling by providing a direct, stable path for light to pass through, which allows for the formation of a vertical facet on the inner wall of cavity 404. Such vertical facet may be advantageous for aligning with the optical path of a silicon and/or silicon nitride waveguide embedded in oxide in subsequent operations when integrating with a PIC, facilitating optimal light transfer.

The structure 400b from FIG. 4B builds on the structure shown in FIG. 4A by introducing a thermal oxide conformal layer (“conformal layer”) 405 grown on the exposed surfaces of the silicon wafer 402 and within the cavity 404. This thermal oxide layer may be conformal, meaning the layer follows the contours of the underlying surfaces, smoothing out irregularities and creating a pristine, flat bonding surface. The conformal nature of the thermal oxide in conformal layer 405 may provide a high-quality, flat bonding surface. Such conformal layer 405 may be advantageous for subsequent hybrid or fusion bonding by creating a pristine, uniform surface that may enhance bonding integrity without the need for further polishing. For example, conformal layer 405 may be grown to a thickness of substantially 0.1 to 1 micron.

As shown in FIG. 4C, once conformal layer 405 is grown, an additional oxide layer 406 may be applied across the entire wafer surface to provide a planarized structure. Such oxide deposition may contribute to facilitating a fully planar surface, making optical structure 400c ideal for hybrid bonding in later stages of the PIC fabrication process.

In FIG. 4D-4E, after the initial cavity has been etched and the thermal oxide layer 406 has been conformally grown across structure 400d, a window 408 may be opened within the oxide layer 406 to allow further processing of the cavity. Such opening may facilitate access to the silicon wafer 402 for creating an angled facet within the cavity for directing light in alignment with optical paths in the PIC. Other facets may be opened to form alignment marker features either through etching or later in deposition operations.

The structure 400e in FIG. 4E depicts the cavity 406 filled with oxide and window 408 after an etching process is performed to create an angled facet 410 on one side of the cavity 406. The angle of this angled facet 410 may be determined by the crystallographic orientation of the silicon wafer and/or the etching process. The crystallographic orientation may be adjusted based on whether the wafer is a <100> orientation or a bias-cut wafer or similar variations describe previously. Such flexibility allows designers to tailor the angle of the facet to optimize light redirection or reshaping, depending on the specific design. Alternatively, if advanced lithography processes are utilized, such as greyscale or imprint, a transfer etching process can enable a mirror flat surface or potentially a curved surface that might further redirect and/or manipulate the beam shape.

Following the angled facet formation, as shown in FIG. 4F, a high-reflectivity (HR) coating 412 may be deposited onto the angled facet 410 on structure 400f. This HR coating 412 may enhance the reflective properties of the angled facet 410, providing minimal light loss and efficient redirection of light within the PIC. The high reflectivity of the coating may maintain optical performance, because HR coating 412 may allow for effective light manipulation without introducing significant signal degradation. The HR coating may be made of layers of varying refractive index materials, such as the dielectric materials mentioned previously, or may be made of metal or a combination thereof.

As shown in FIG. 4G, the cavity may be filled with an oxide material similar to or the same as oxide layer 406, covering the HR-coated angled facet 412. This oxide fill may stabilize the structure and prepare the surface for hybrid or fusion bonding. The oxide fill may also act as an index-matching material, reducing back reflections and helping to minimize insertion loss within the PIC.

FIG. 4H may introduce the handle wafer 414, which may be attached to the backside of the silicon wafer 402 to provide additional mechanical support during subsequent processing operations such as removal of the original silicon wafer. Once the handle wafer 414 is attached, the original silicon wafer 402 may be removed through grinding and/or a selective etching process, leaving behind the prepared reflective structure encased within a high-quality oxide layer 406. Additionally, the remaining oxide surface is pristine and atomically flat (<0.5 nm) to enable hybrid or fusion bonding to a PIC to embed the mirror element into the PIC and aligned to a waveguide. This surface can then also act as a mechanical stop to enable, along with fiducials, precise alignment in all axes.

The advantage of this oxide-based mirror structure is evident in the context of optical performance. Oxide may offer a refractive index that may be better matched to silicon or silicon nitride (SiN) waveguides embedded in oxide, which may be commonly used in PICs. This close index matching may reduce reflection losses at the interface without the need for further process steps to integrate AR coatings, resulting in lower cost, higher yield, lower insertion loss (IL) and improved signal clarity. The oxide layer may also enhance the overall stability and durability of the structure and thermal-expansion matching, making it well-suited for high-performance PIC applications that demand low reflectivity, minimal signal degradation and high reliability over a large range of temperatures.

The final structure (i.e., structure 400h), after the removal of the original silicon wafer, may include the HR-coated angled facet 412 and the surrounding oxide layer 406 bonded to the handle wafer 414. This oxide-based reflective surface with a precisely angled HR coating may facilitate efficient light redirection optimized for integration with other optical and electronic components within PICs. The configuration may be used for hybrid bonding applications, because the oxide surface may be planar, robust, and free from defects that may compromise bonding integrity. Advantageously, integration without optical epoxy, or optical epoxy-free hybrid bonding, may be facilitated and thus may withstand the high temperatures of subsequent processing operations used in silicon and package level manufacturing.

Overall, this oxide-based mirror structure may provide enhanced optical performance through reduced insertion loss and better index matching, facilitating its use in advanced PIC systems to provide efficiency and stability.

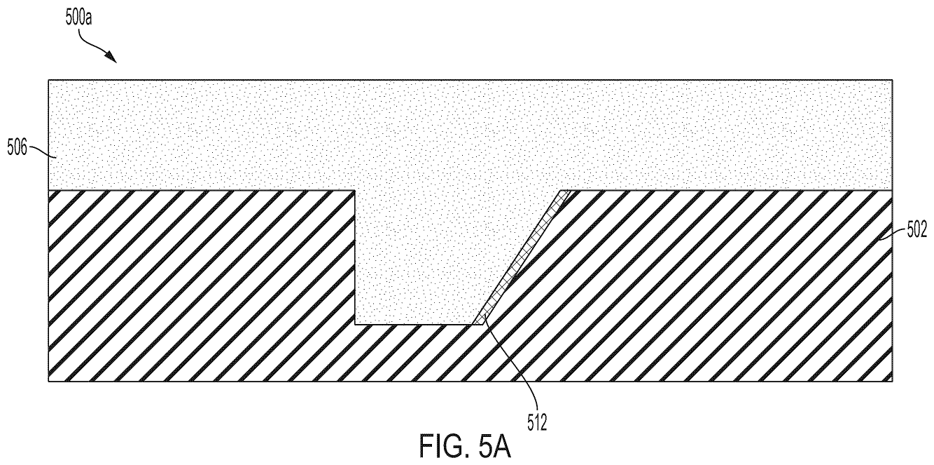

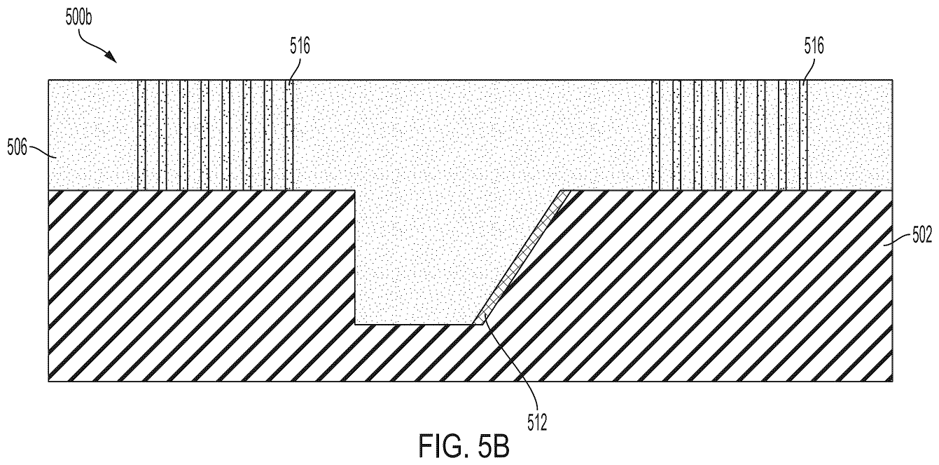

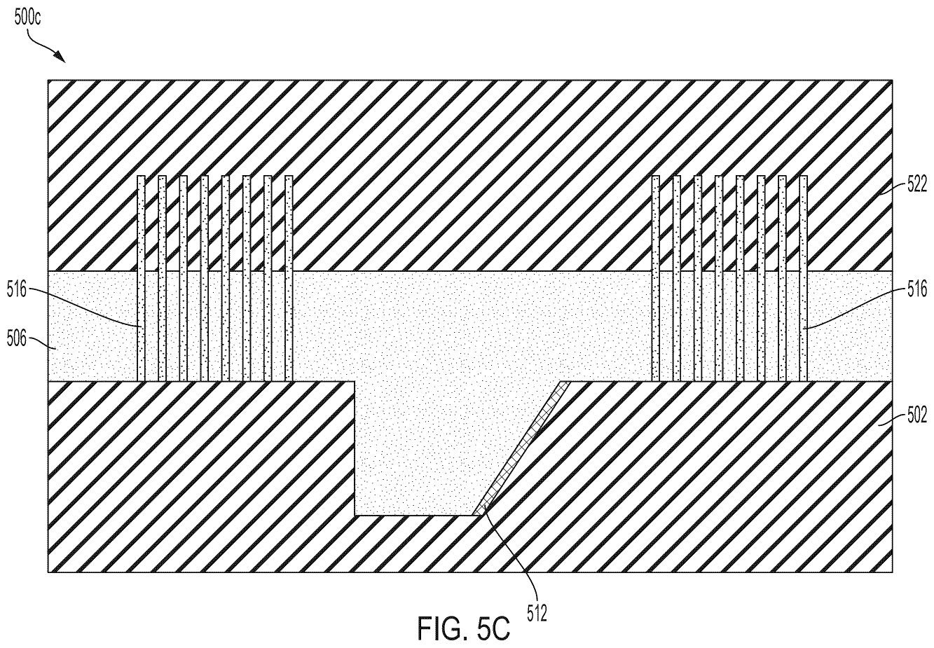

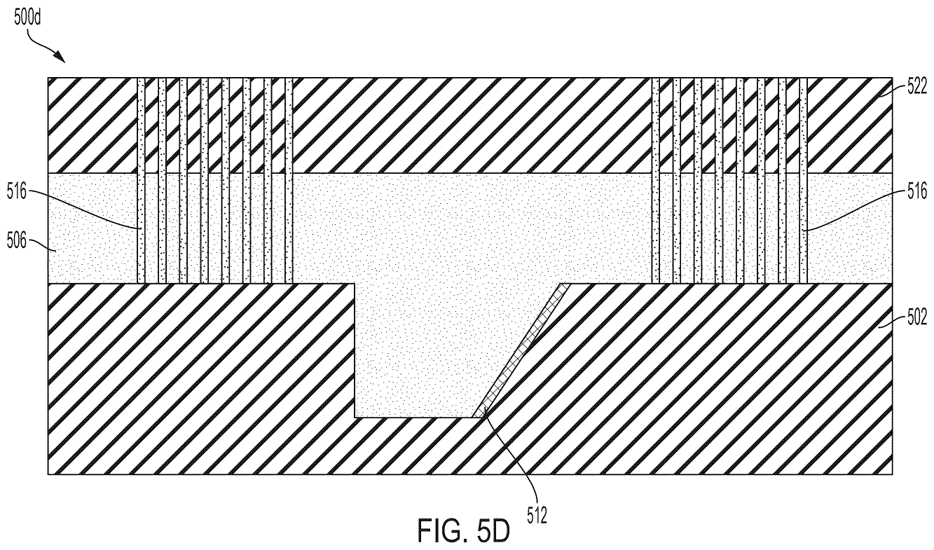

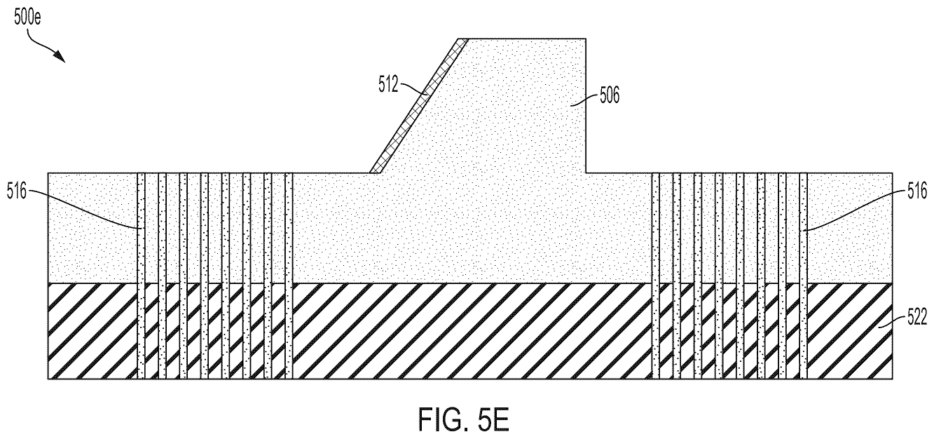

FIGS. 5A-5E depict a formation process for a silicon photonic device with embedded vias. FIG. 5A depicts a photonic structure 500a. Photonic structure 500a may be the same or similar to photonic structure 400g above, wherein similarly labeled parts corresponding to similar features have similar functionality. The description below builds upon previous devices and methods described above, and also incorporates additional structural and processing steps to enable enhanced connectivity and structural stability, particularly through the inclusion of through-dielectric vias (TDVs) and through-silicon vias (TSVs), collectively referred to as “vias”. Such features allow for advanced integration of optical components with the PIC's electrical infrastructure, via epoxy-free hybrid bonding.

In FIG. 5A, a process may begin with silicon wafer 502, in which a cavity has been etched to include an angled facet 512. The angled facet 512 may be prepared to later receive a high-reflectivity (HR) coating, which may provide the light redirection or reshaping to align with other optical paths in the PIC. This cavity may be created using precise etching techniques, such as deep reactive ion etching (DRIE) or wet etching or other advanced etching processes, which may allow for control over the facet's angle. The angle may be tailored based on the crystallographic orientation of the wafer, such as <100> or bias-cut silicon, to optimize optical performance for specific design. A conformal layer of thermal oxide 506 may be grown across the silicon wafer and within the cavity, providing a smooth, high-quality surface for further processing.

In the structure 500b in FIG. 5B, through-dielectric vias (TDVs) 516 may be formed within the thermal oxide layer 506. These TDVs 516 may provide electrical connectivity through the dielectric material, allowing for integration with other electrical components within the PIC. TDVs 516 may be created by etching narrow holes through the thermal oxide layer and then filling these holes with conductive material, such as metal. The placement and density of TDVs 516 may be customized to match the electrical usage of the final device, allowing for versatile design options in PIC applications. This feature may provide flexibility in design, because TDVs 516 allow electrical signals to be routed through the dielectric layer, providing seamless electrical interfacing with the optical structure.

An operation may introduce an additional silicon wafer layer 522, which may be bonded to the existing oxide-filled structure, as shown in the structure 500c in FIG. 5C. This added layer may provide several potential benefits. Firstly, it may serve to thicken the overall wafer structure, adding mechanical strength and stability, which may be advantageous for handling and further processing. Secondly, if the initial structure includes blind TSVs, this additional silicon layer may be thinned in specific regions to reveal and access these TSVs as shown in FIG. 5D, enabling metallization and full electrical connectivity through the wafer stack. Alternatively full TSVs at the selected thickness may be integrated in a similar fashion without subsequent thinning processes. By incorporating these metallized TSVs, the structure 500d may gain enhanced electrical functionality, making structure 500d ideal for applications that use complex interconnections within a small form factor.

FIG. 5E shows structure 500d after being flipped and the original silicon wafer 502 has been selectively etched away, exposing the oxide layer 506 and the metallized vias 516, thereby forming structure 500e. This selective etching process may leave behind a clean, uniform oxide surface and establish the final configuration of the optical structure, which may now include a high-reflectivity angled facet 512 and robust electrical pathways. The HR angled facet 512, which remains encapsulated within the oxide, may provide efficient light redirection with minimal insertion loss, while the metallized TDVs or TSVs provide electrical connectivity. The flat surfaces of the oxide enable hybrid or fusion bonding as well as precise mechanical stops, which when combined with alignment fiducials, can provide precise placement in all axes.

Thus, structure 500e may combine high-precision optical and electrical integration in a single component, designed to meet the demands of complex photonic applications. PIC designs may use separate components or additional processing steps to achieve both optical and electrical interconnectivity. However, this method may integrate these functionalities directly within the wafer, reducing complexity and providing a more compact design.

The use of TDVs and TSVs may allow the optical structure to be part of an interconnected network of electrical and optical components, supporting high-speed data transfer, signal processing, and real-time monitoring applications. By embedding these electrical pathways directly into the oxide layer and through the silicon wafer, the method may facilitate integration with additional electrical circuits or control systems that may be used for the operation of advanced PICs, such as those found in telecommunications, data centers, and sensing applications.

Additionally advantageous may be the robustness of the resulting structure 500e. By filling the cavity with oxide, structure 500e may be made more resilient to thermal and mechanical stresses. The oxide fill and the additional silicon layer may contribute to stability, during high-temperature processing or when the device is subjected to operational thermal cycling. This stability may be advantageous in applications where long-term reliability and performance are useful, such as in mission-critical communication systems or precision sensing devices.

Furthermore, the HR angled facet 512 may enhance optical efficiency. The high reflectivity may ensure that light may be redirected or reshaped with minimal signal loss, which may maintain the quality of optical transmission. The ability to customize the angle of the facet according to design may also allow for optimal alignment with other waveguides or optical components, providing efficient coupling and reducing potential losses.

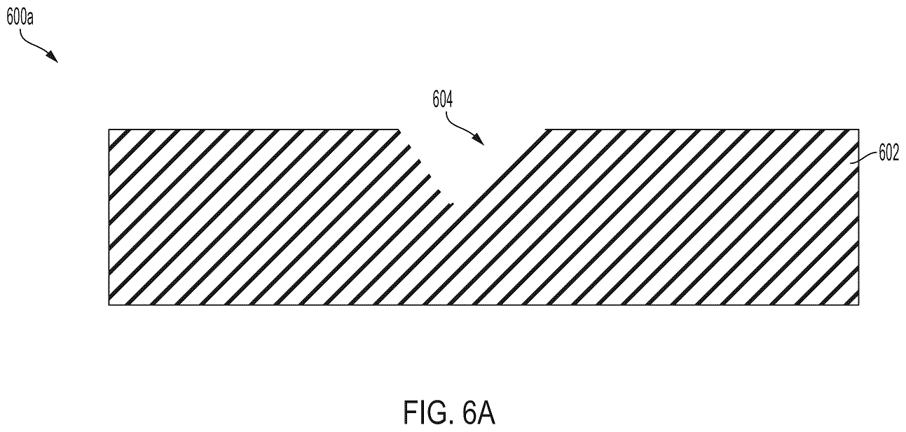

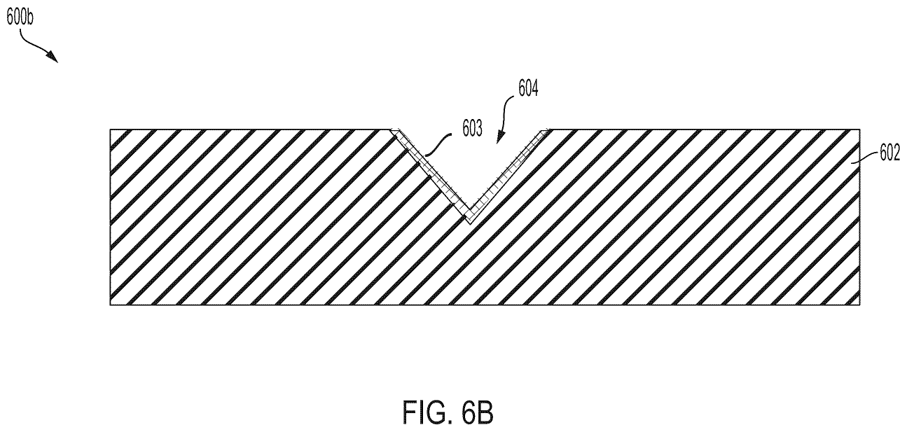

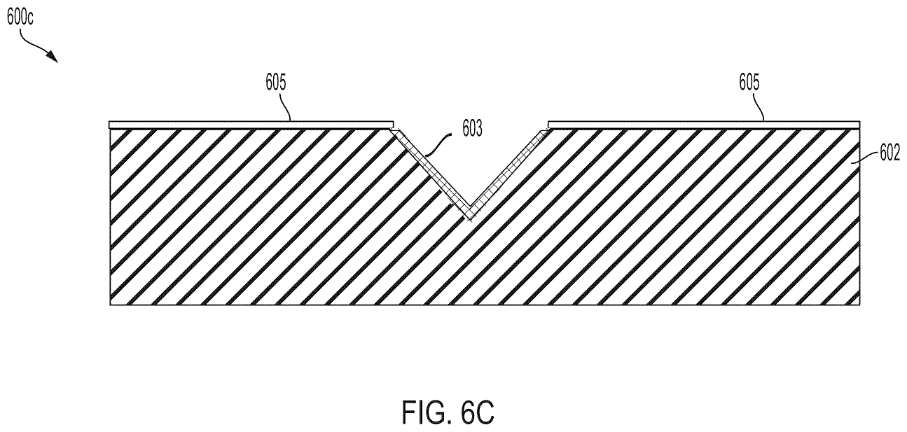

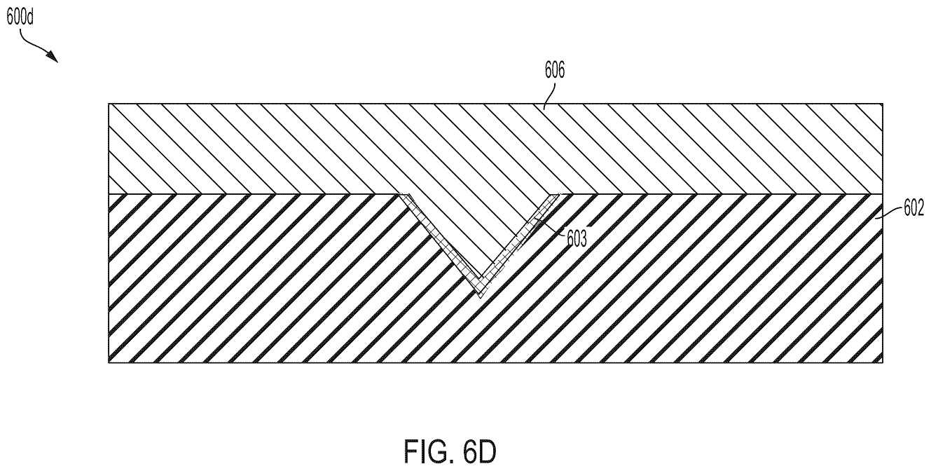

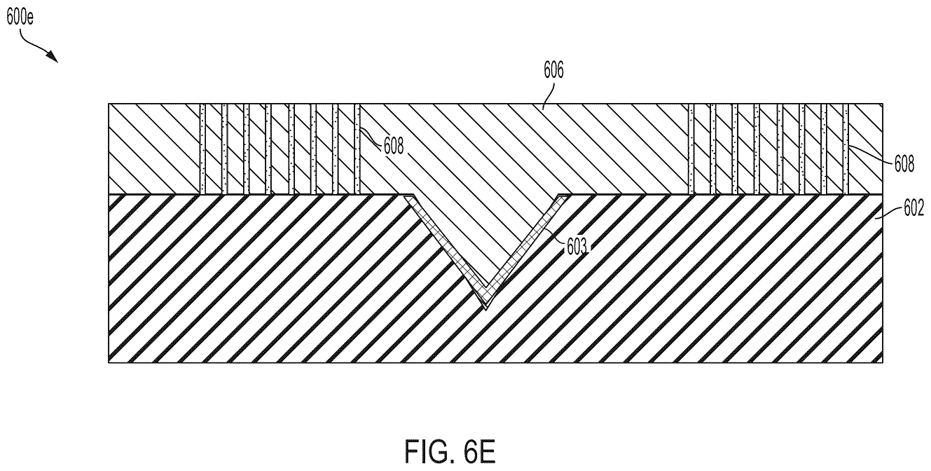

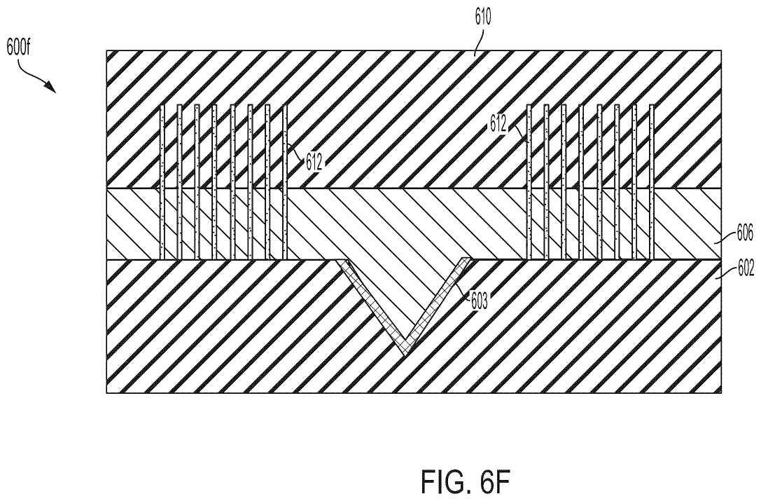

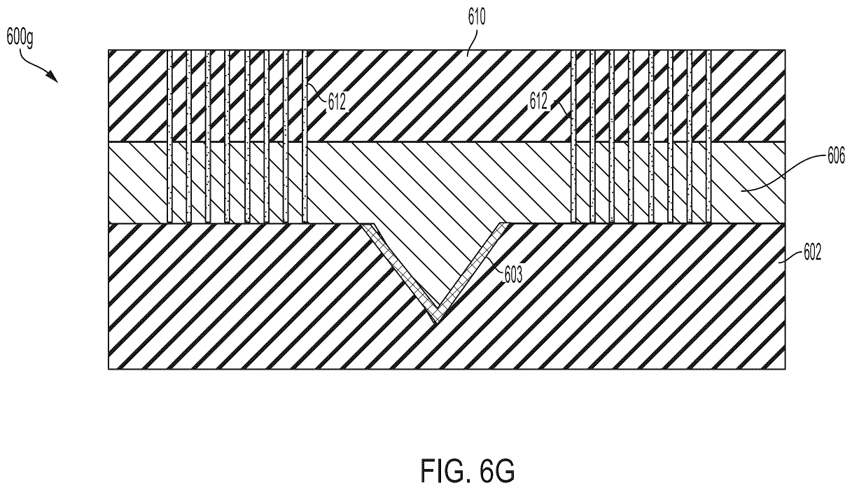

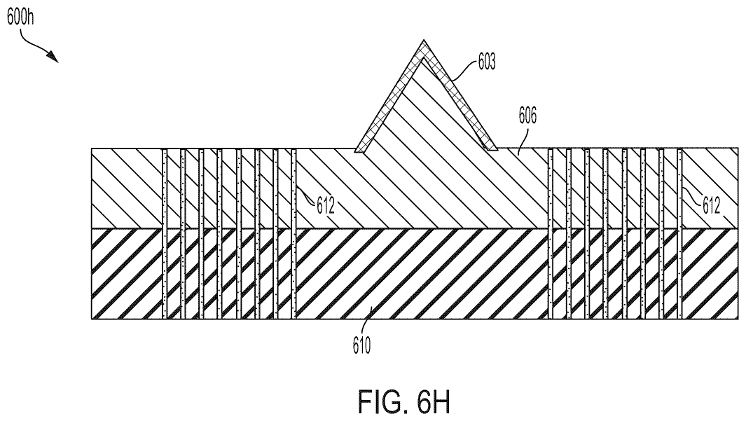

FIGS. 6A-6H illustrate a device and method for forming an optical structure with an angled reflective surface within a silicon wafer substrate, using a sequence of operations that provide high precision and stability for integration with photonic integrated circuits (PICs). This may involve creating a reflective facet with an optimized angle and high-reflectivity coating, surrounded by oxide layers, and incorporating through-dielectric vias (TDVs) or through-silicon vias (TSVs) for advanced electrical connectivity. This structure may be designed for hybrid or fusion bonding with other components, such as PICs, supporting high-performance optical and electrical integration within a compact layout.

As shown in the structure 600a in FIG. 6A, a process may begin with a wet etching operation that may form an angled facet within a silicon wafer 602. This wet etch may produce a V-shaped trench 604 with sloping sidewalls, which may also have a flat bottom depending on the design. The angle of these facets may be determined by the crystallographic orientation of the silicon wafer, such as <100> silicon, which may allow for predictable and controlled etching angles. The wafer crystal orientation may be modified through different starting seeds (e.g. <111>, >311>, or <511>) or through angled cutting to achieve specific final angles used for the optical integration. This angled surface may serve as a reflective facet, directing light paths within the PIC. The etching process may be controlled to create smooth and precise facets for optimal light redirection. Alterative starting wafers with different crystalline orientations may be used to facilitate different angles depending on the application. Other advanced processing techniques, such as greyscale or imprint lithography and transfer etching, may be used.

The structure 600b in FIG. 6B shows the application of a high-reflectivity (HR) coating 603 onto the angled facets created within the V-shaped trench 604. Such coating may be applied to one or both facets or to the entire surface conformally, depending on the specific optical design. The HR coating material, such as a metal and/or dielectric reflective layers, may provide a highly reflective surface that may minimize signal loss due to scattering or absorption. A surface may be highly reflective when the surface has a reflectance of 95% or greater. This coating may provide that light is efficiently redirected within the PIC with minimal insertion loss, supporting high-performance and high-power optical applications. The ability to coat both sides of the V-shaped trench 604 offers design and process flexibility, allowing for optimized reflection based on the intended light path. If the coating is conformal everywhere, a subsequent CMP or similar process may be used to remove it from the flat surface to aid in the next step. Alternatively, the next operation in FIG. 6C may occur prior to the operation in FIG. 6B, which may be advantageous if further smoothing of the mirror surface is used prior to the HR deposition.

In the structure 600c in FIG. 6C, a thermal oxide layer 605 may be grown over the exposed surfaces of the silicon wafer, including within the V-shaped trench 604 if done prior to the HR deposition. This oxide layer, which may be grown to a thickness of 0.1 to 1 micron, may conform to the surface contours to create a flat and pristine bonding surface. The thermal oxide layer 605 may provide electrical insulation and enhance the structural stability or smoothness of the V-shaped trench 604. Because the oxide layer may be grown thermally, it may form a uniform, high-quality layer that does not use additional polishing, providing an ideal surface for further processing and later as a hybrid or fusion bonding layer. This process operation may occur prior to or after deposition of the HR coating.

Following the oxide growth, structure 600d in FIG. 6D illustrates the deposition of an additional oxide layer 606 across the entire surface, including over the trench. This oxide deposition may be planarized to achieve a flat, even surface. The planarized oxide layer may stabilize the structure and prepare it for the creation of TDVs in subsequent operations. Planarization may provide that the surface is flat for high-quality hybrid bonding, reducing the risk of misalignment or bonding defects in the final assembly.

As shown in structure 600e in FIG. 6E, TDVs 608 may be created within the oxide layer. These TDVs 608 may be formed by etching narrow holes through the oxide layer, which may be filled with conductive material, such as metal, to establish electrical pathways. The TDVs 608 may provide vertical electrical connectivity within the structure 600e, allowing for integration with additional electronic components in the PIC. The ability to route electrical signals through the dielectric layer may enable compact, multifunctional design layouts for advanced PIC applications.

FIG. 6F depicts the structure 600f after a silicon wafer layer 610 has been bonded on top, adding mechanical support and further protecting the underlying reflective facet. This additional silicon wafer layer 610 may include blind TSVs 612, which may be partially filled conductive vias or unfilled vias that may not extend through the thickness of the wafer. These blind TSVs 612 may be revealed and completed in later operations, providing additional electrical connectivity or additional thickness of the component. Alternatively, the final thickness with full vias may be incorporated instead through hybrid bonding.

In the structure 600g in FIG. 6G, the backside of the silicon wafer may be thinned down to reveal the TSVs 612, which may now be metallized to establish a full electrical connection. This thinning process may be carefully controlled to provide precise exposure of the TSVs 612 while maintaining the structural integrity of the silicon wafer. The metallization of the TSVs 612 may complete the vertical electrical pathway, allowing for efficient signal transmission through the PIC. This configuration may support applications that use optical and electrical connectivity in close proximity, enhancing the functionality and integration density of the device.

Finally, in FIG. 6H, the fully processed structure 600h is shown, with the oxide-encased, HR-coated angled facet 603 and the metallized TDVs or TSVs 612 in place. This configuration may offer a highly reflective, thermally stable, and electrically accessible optical structure, ready for hybrid bonding within the PIC. The oxide filling surrounding the HR-coated angled facet 603 may help to minimize unwanted reflections by providing a refractive index close to that of silicon or silicon nitride (SiN) waveguides embedded in oxide during PIC integration. This may reduce insertion loss and improve overall optical performance, making this structure 600h well-suited for high-precision optical applications. Alternatively, 600h may enable a light path outside of the structure through air or other materials that might fill in the structure 600h in any post processes during integration with a PIC. The final surface that remains above the oxide may provide a pristine surface that may allow for fusion or hybrid or similar bonding to eliminate optical epoxies that cause challenges in reliability and yield.

The integration of TDVs and TSVs may enable the structure to support optical and electrical pathways, to be used for multifunctional PICs that use both types of connectivity. This versatility may allow designers to create compact, high-performance photonic devices suitable for applications in telecommunications, data center networking, and high-speed computing, where both light manipulation and electrical control may be useful.

The structures shown in FIGS. 6A-6H provides a range of benefits over traditional optical integration methods. By forming an angled reflective facet with a high-reflectivity coating and surrounding it with oxide, this method may facilitate low insertion loss and high reflectivity for maintaining signal quality within the PIC. The oxide material may offer a close refractive index match to SiN or even Si waveguides embedded in oxide and thus guiding as mode size conversion forces the light into that surrounding material, minimizing reflections at interfaces and enhancing light transmission efficiency.

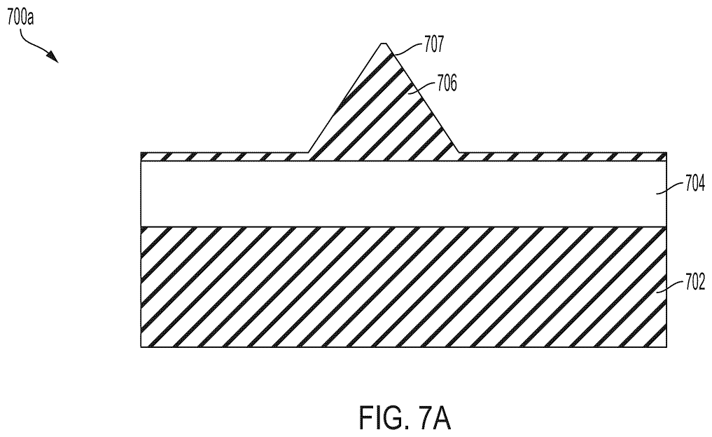

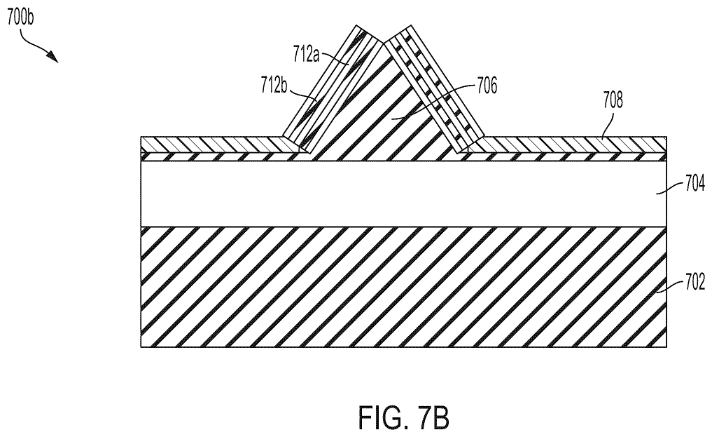

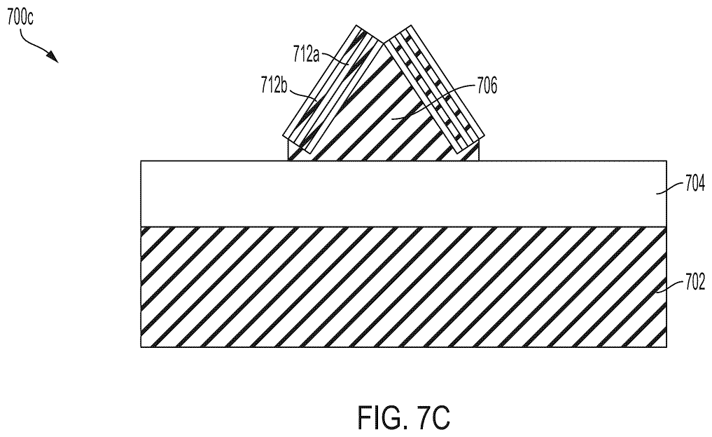

FIGS. 7A-7C depict an alternate method for creating a similar structure as FIG. 6H but using silicon as the final material to support the mirror rather than oxide. Silicon can have a high thermal conductivity that can help support any optical power converted to heat to dissipate more readily and can be advantageous.

As illustrated in FIG. 7A, a structure 700a may include an SOI wafer 702, an oxide layer 704, and a silicon layer having an angled facet 707. The angled facet 707 may be formed by using wet etching or advanced etching techniques described previously. When using wet etching, the silicon material may be removed from the surface except for where the structures remain. A thin layer of silicon may remain as protection to the oxide layer 704 so that the oxide layer 704 may be used for hybrid or fusion or similar bonding to a PIC. The angle of the etched surface may be dependent on the silicon layer 706, which may be a traditional <100> silicon or <111>, <311>, <511> or an offcut axis of any of these for a specific final angle. Alternatively, the angle may be formed through advanced greyscale or imprint lithography followed by transfer printing or replication processes. In some other cases, the oxide may not be used if using advanced materials to form the bond similar to hybrid bonding.

As illustrated in FIG. 7B, the structure 700b may be formed by masking 708 the silicon layer 706 then growing oxide to smooth the surface of the structure. HR mirror pairs 712a, 712b may be deposited on one or both sides of the angled facet 707. Alternatively, anti-reflective coating may be deposited on one side of the angled facet 707 and the other side of the angled facet 707 may include a mirror (which may be created using TIR or HR coatings). These components may be used in conjunction with AR features (as described with respect to FIGS. 1A-1D and 2A-2D).

As illustrated in FIG. 7C, the structure 700c may be formed by selectively wet etching the remaining protective silicon after removal of the mask 708 to reveal the surface of the oxide layer 704. The revealed surface of the oxide layer 704 may be used for hybrid or fusion bonding or similar bonding techniques that may exist today or in the future in advanced manufacturing.

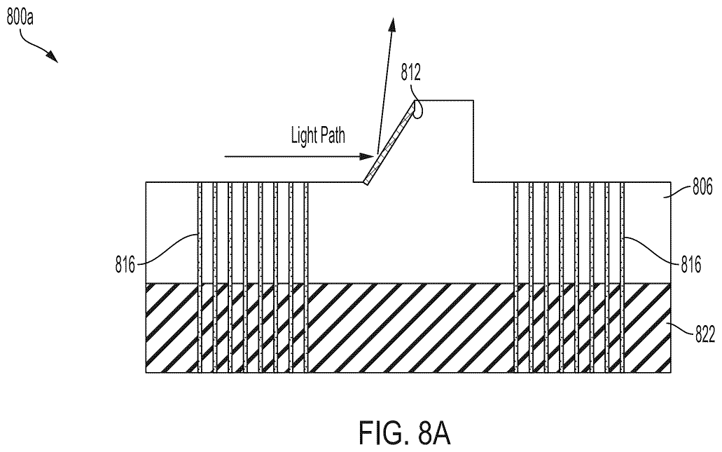

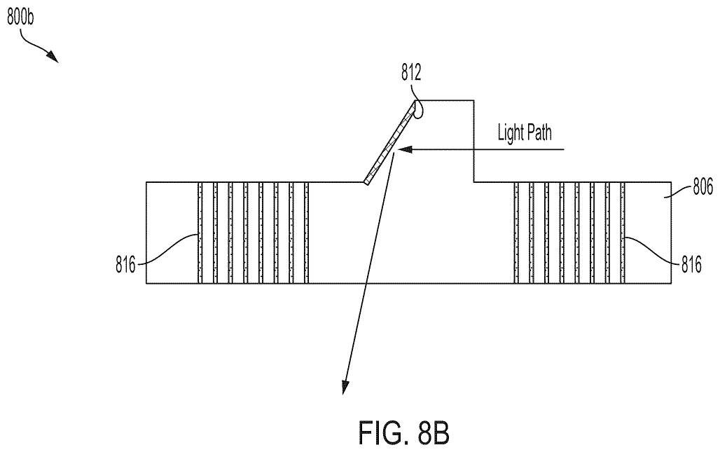

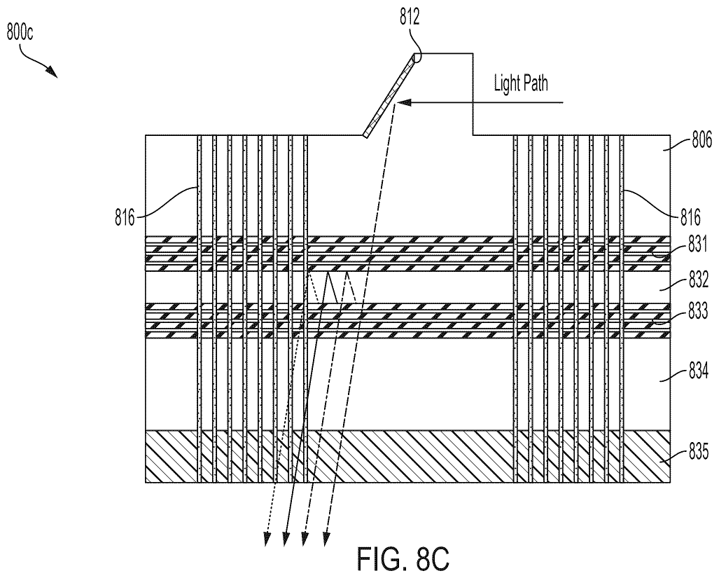

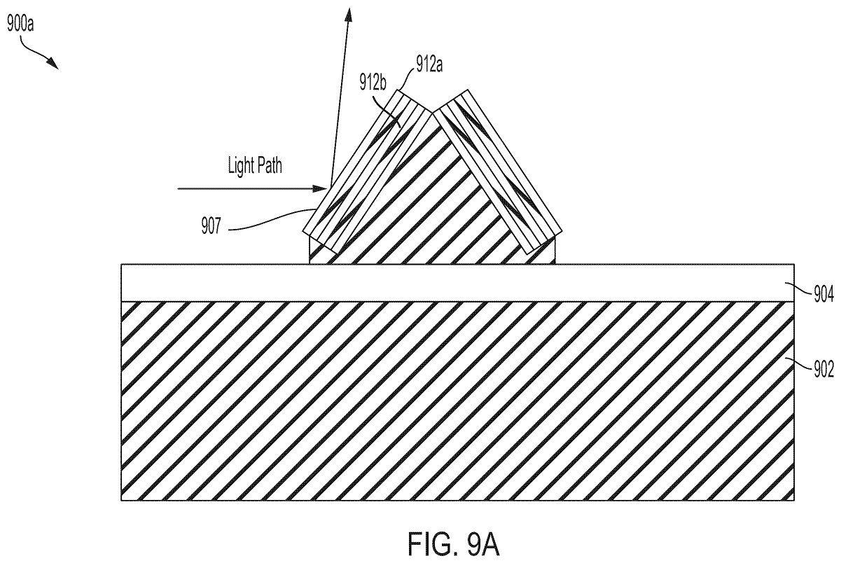

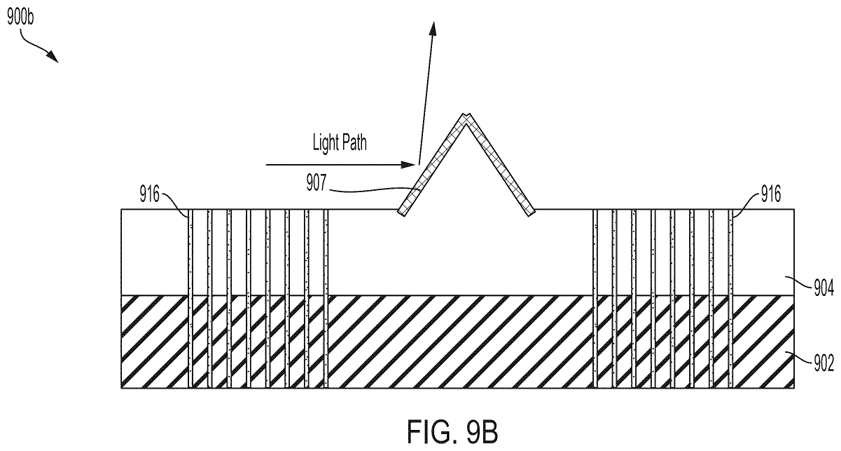

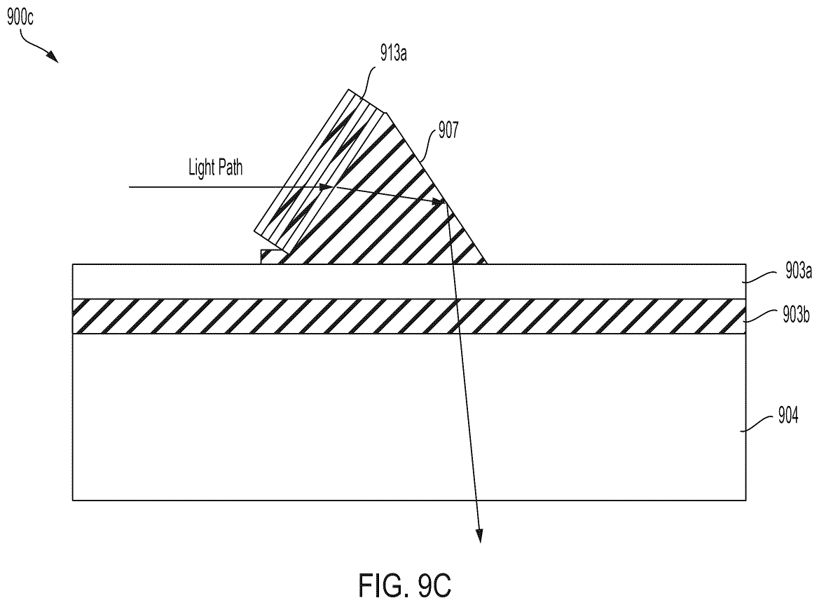

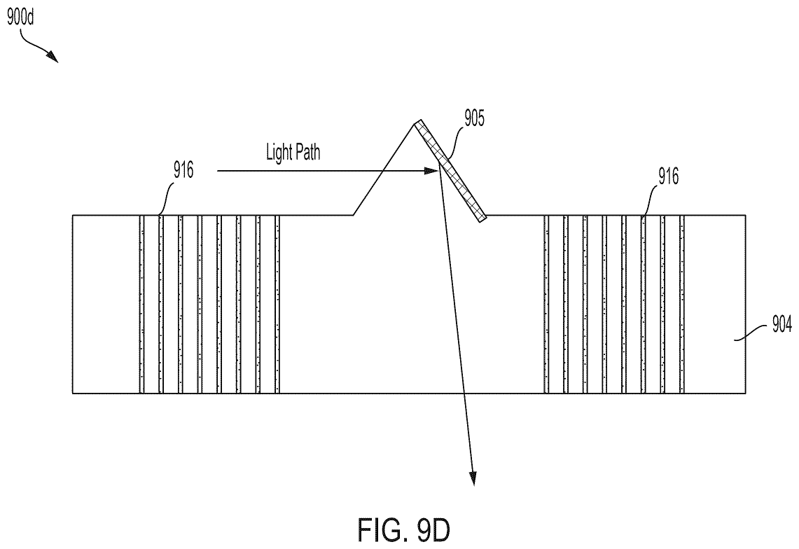

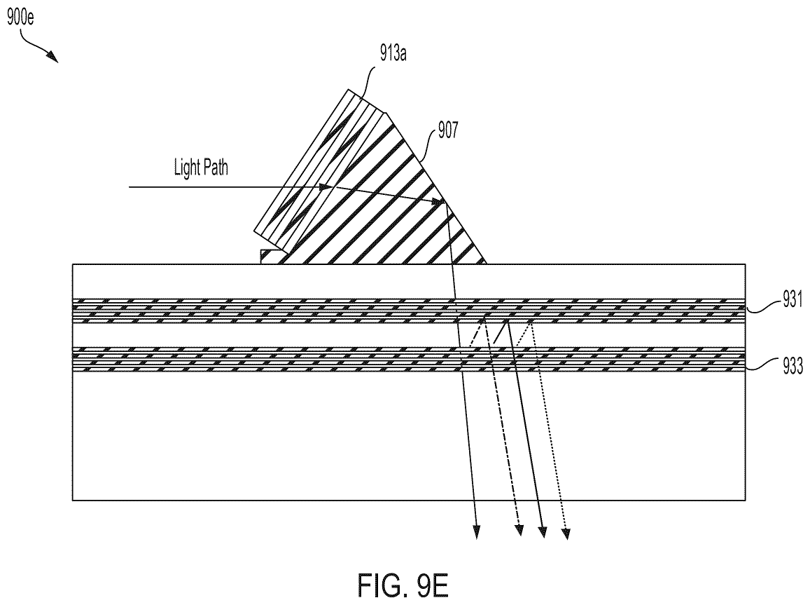

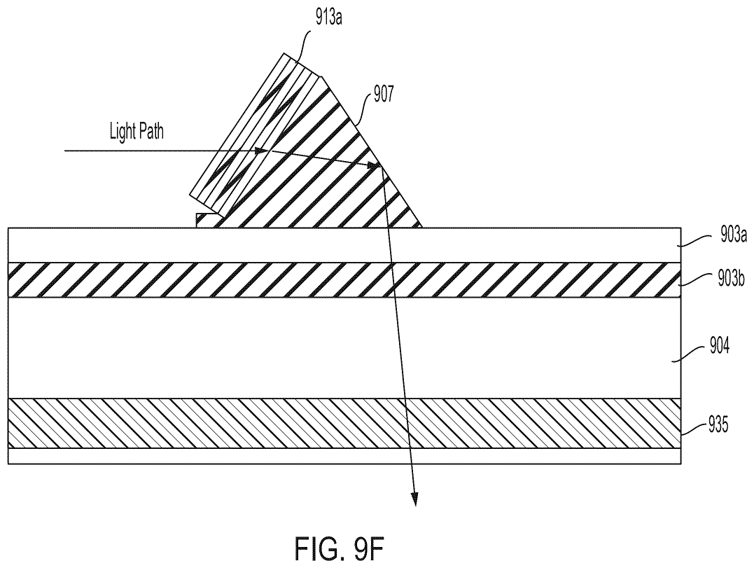

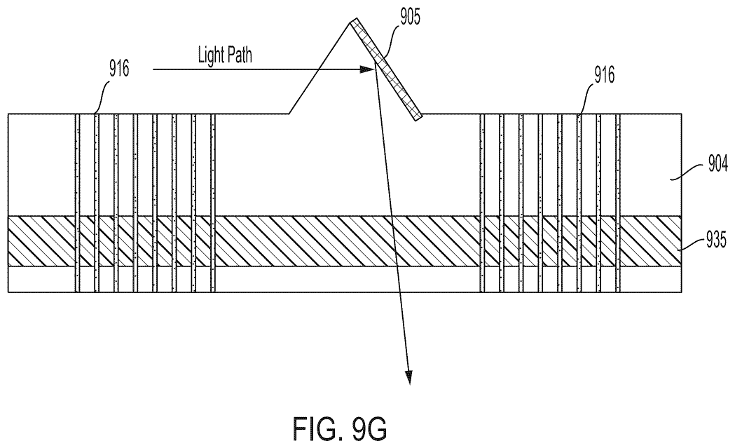

FIGS. 8A-8C and FIGS. 9A-9G show exemplary light propagation paths through these optical devices created as described in this disclosure. While not all combinations are shown, these intend to give examples of how various elements described previously might be incorporated into various structures depending on final application designs. Other components may be embedded within these structures including electrical vias, meta materials, micro-lenses, polarization splitters, and multiplexing/demultiplexing structures. The intent is to enable features that can effectively separate wavelengths and/or polarization of light, modify the beam propagation direction and/or shape (e.g. collimating elements, lensing elements, etc), reflect the light (e.g. mirror elements), and/or allow light to pass through with minimal loss and backreflections as well as to enable electrical connectivity.

FIG. 8A illustrates a structure 800a that may include a silicon wafer layer 822, an oxide layer 806, vias 816, and an angled facet 812. As shown by the arrows, light may be directed to the light path and may reflect off the angled facet 812 towards the top of the structure 800a.

FIG. 8B illustrates a structure 800b that may include an oxide layer 806, vias 816, and an angled facet 812. As shown by the arrows, light may be directed to the light path and may reflect off the angled facet 812 towards the base of the structure 800b.

FIG. 8C illustrates a structure 800c that may include an oxide layer 806, vias 816, an angled facet 812, dielectric stacks 831, 833, oxide layer 832, oxide layer 834, and a meta surface 835. The light may be directed to the light path as shown by the arrows and may reflect off the angled facet 812 towards the base of the structure 800c. In this structure, the light is split either by wavelength or polarization or both and potentially reshaped into a collimating beam to enable further integration with other optical components, such as fibers, waveguides, mirrors or lenses. This structure may also enable electrical connectivity though electrical vias 816. The splitting in wavelength and/or polarization may be in either direction depending on the application.

FIG. 9A illustrates a structure 900a that may include an SOI wafer with silicon layer 902 and an oxide layer 904, an angled facet 907, and HR mirror pairs 912a, 912b. The light may be directed to the light path where it may reflect off the HR mirror pair 912a, 912b (or multiples thereof and/or metal with high reflectivity) towards the top of the structure 900a.

FIG. 9B illustrates a structure 900b that may be like the structures shown in FIGS. 6A-6H with a similar light path to FIG. 9A where the light bounces off an HR mirror surface (made by either dielectric pairs and/or metal). In this structure, electrical vias 916 are also included to enable electrical conductivity.

FIG. 9C illustrates a structure 900c that may include an SOI wafer with an oxide layer 904, an AR structure 903a, 903b, an angled facet 907, and an AR coating 913a made of dielectric layer pairs. The light may be directed to the light path where it may be directed through the AR coating 913a and reflect off the other side of the angled facet 907 either through TIR or a high-reflectivity coating towards the AR structure 903a, 903b at the base of the structure 900c.

FIG. 9D illustrates a structure 900d that has a similar optical propagation path as FIG. 9C but incorporated in a structure made out of oxide only (e.g., oxide 904), enabling a process that does not use AR embedded layers. Additionally, this structure shows an example where electrical connectivity can also be formed as shown by electrical vias 916. There may be a mirror coating 905 on the structure 900d.

FIG. 9E illustrates a structure 900e that enables integration of multiplexing/demultiplexing layers into the structure to enable wavelength splitting/combining or potentially polarization splitting/combining. Depending on the application this can be done either direction (where light is integrated into one path inside or outside of the PIC). The structure 900e may include dielectric stacks 931, 933.

FIG. 9F illustrates a structure 900f that incorporates both an AR embedded structure as well as a meta-surface 935 to enable light manipulation, either through shape, wavelength or polarization. These features could also be embedded with any combination of mux/demux or polarization splitting/combining features. The meta surface may also be replaced with embedded micro-lenses or other optical elements.

FIG. 9G illustrates a structure 900g that is similar to FIG. 9F but shows vias incorporated through a different manufacturing process.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter.

The methods described and/or semiconductor device components as part of or apart from the photonic IC may facilitate communication with a number of processing units (e.g., xPUs), switch ASICs, memory, or other similar ASICs requiring off-chip communication. One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and may interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” (or “computer readable medium”) refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” (or “computer readable signal”) refers to any signal used to provide non-transitory machine readable instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

Thus, the disclosure above provides a novel integrated optical device and method for forming the same, optimized for hybrid or fusion bonding within photonic integrated circuits (PICs). By incorporating a high-reflectivity coated angled cavity within a silicon substrate, combined with a planar oxide bonding surface, the disclosure herein ensure efficient light redirection and manipulation with low insertion loss. The inclusion of through-dielectric vias (TDVs) and optional through-silicon vias (TSVs) enables robust electrical connectivity, allowing for seamless integration with electronic components in complex PIC architectures. The optical devices of the disclosure above achieve both high optical performance and electrical interfacing within a stable, scalable structure, making it ideal for applications that have compact, high-density layouts, such as telecommunications, data center networking, and high-speed computing. The examples described above addresses challenges in epoxy-free PIC integration, offering a versatile, high-performance solution that enhances both optical and electronic functionality in advanced photonic systems via epoxy free hybrid bonding, as described above.

### EXAMPLES

Example 1 may include a method for forming an integrated optical structure in a silicon wafer for non-epoxy hybrid bonding in a photonic integrated circuit (PIC). The method may include etching a first silicon wafer to create a cavity with one or more sloped sidewalls, an angle of the one or more sloped sidewalls being determined by a crystallographic orientation of the silicon wafer or via other advanced lithography or replication techniques (e.g. greyscale or imprint); depositing a high-reflectivity (HR) coating on at least one sloped sidewall of one or more sloped sidewalls to create a reflective surface for directing or reshaping light within the PIC; thermally growing a first oxide layer over exposed surfaces of the silicon wafer, including within the cavity, to a thickness of approximately 0.1 to 1 micron, thereby creating a first planar surface; depositing a second oxide layer over the first oxide and planarizing the second oxide layer to create a second planar surface; and bonding a second silicon wafer onto the second planar surface and removing the original silicon wafer via selective wet etching, thereby creating a structure configured for non-epoxy hybrid bonding.

Example 2 may include the method of Example 1 and may further include forming through-dielectric vias (TDVs) in the second oxide layer by etching a plurality of holes and filling the plurality of holes with a conductive material, thereby establishing vertical electrical connections through the second oxide layer.

Example 3 may include the method of Example 2 and may further include forming through-silicon vias (TSVs) in the second silicon wafer, in which the TSVs extend through less than an entire thickness of the second silicon wafer.

Example 4 may include the method of Example 3 and may further include thinning a backside of the second silicon wafer to expose the TSVs; and metallizing, subsequent to thinning, the TSVs to complete the electrical connection through the second silicon wafer.

Example 5 may include the method of Example 4 and may further include etching and removing at least a portion of the first silicon wafer to expose the oxide-encased reflective surface and one or more conductive pathways provided by the TDVs and TSVs.

Example 6 may include the method of Example 1, in which the reflective surface may be encased in oxide and provides improved optical performance by reducing insertion loss and minimizing reflections through refractive index matching with silicon nitride (SiN) waveguides or silicon waveguides embedded in oxide.

Example 7 may include the method of Example 1, in which the completed structure may be configured for non-epoxy hybrid bonding to other photonic and electronic components in the PIC.

Example 8 may include a device configured for non-epoxy hybrid bonding in a photonic integrated circuit (PIC), the device including: a silicon wafer substrate having a cavity with an angled facet; a thermally grown oxide layer covering the silicon substrate, including within the cavity, to form a planar, high-quality bonding surface; a high-reflectivity (HR) coating applied to the angled facet within the cavity, the HR coating configured to direct or reshape light within the PIC by reflecting light along a predetermined optical path; and a handle silicon wafer bonded to the backside of the oxide layer for structural support and stability during epoxy-free integration with other PIC components.

Example 9 may include the device of Example 8, in which the oxide layer may provide a refractive index closely matched to silicon nitride (SiN) waveguides or silicon waveguides embedded in oxide, thereby minimizing insertion loss and reflections when integrated within the PIC.

Example 10 may include the device of Example 8 in which the device may be configured to allow non-epoxy hybrid bonding with additional photonic or electronic components, enabling efficient light redirection and high optical performance.

Example 11 may include an optical device configured for non-epoxy integration in a photonic integrated circuit (PIC), the optical device including: a silicon wafer including a V-shaped cavity with angled sidewalls or a cavity with similar angled sidewalls but a flat base configured to direct or reshape light within the PIC; a thermally grown oxide layer covering the silicon substrate, including within the V-shaped cavity, forming a planar bonding surface for later hybrid or fusion bonding; a high-reflectivity (HR) coating applied to the angled sidewalls within the V-shaped cavity to facilitate efficient light reflection along a predetermined optical path; a filling of the cavity and planarization with oxide; a plurality of through-dielectric vias extending through the oxide layer, each filled with a conductive material to provide vertical electrical connections through the oxide layer; and a handle silicon wafer bonded to the backside of the oxide layer for structural stability and support. Removal of the original silicon via selective wet etching to reveal the pristine oxide surface for hybrid bonding.

Example 12 may include the optical device of Example 11, in which the oxide layer may be configured to have a refractive index closely matched to oxide to reduce insertion loss and unwanted reflections.

Example 13 may include the optical device of Example 11, in which the through-dielectric vias (TDVs) may allow for electrical interfacing, enabling integration with additional electronic components in the PIC.

Example 14 may include the optical device of Example 11, in which the optical device may be structured for hybrid bonding with other photonic and electronic components, providing efficient optical reflection through the HR-coated angled sidewalls and electrical connectivity via the TDVs.

Example 15 may include a method of manufacturing a photonic device with an embedded anti-reflective (AR) stack, including: providing a first silicon layer; positioning a first oxide layer on the first silicon layer to form a first layer of the embedded AR stack; positioning a second silicon layer on the first oxide layer to form a second layer of the embedded AR stack; positioning a second oxide layer on the second silicon layer to form a buffer configured to enable revealing and/or index matching to one or more optical components of the photonic device; bonding a silicon wafer to the second oxide layer, thereby forming a photonic structure; inverting the photonic structure and thinning the first silicon layer through a backgrinding or chemical-mechanical polishing (CMP) process, thereby forming a thinned first silicon layer; etching a vertical facet configured for light coupling into the thinned first silicon layer; and etching a second angled facet into the thinned first silicon layer thereby forming the photonic device with the embedded AR stack, in which the second angled facet may be configured for light redirection substantially vertically through the embedded AR stack.

Example 16 may include the method of Example 15 and may further include etching the second angled facet utilizing a wet etching process with a standard (100) silicon orientation, resulting in a facet angle of substantially 54.7°.

Example 17 may include the method of Example 15 and may further include etching the second angled facet utilizing a bias-cut silicon ingot or different silicon crystal seed (e.g. <111>, <311>, or <511>), resulting in a facet angle in a range between substantially 35° and 55°.

Example 18 may include the method of Example 15 and may further include etching of the second angled facet via more advanced manufacturing processes such as greyscale lithography or nano-imprint lithography.

Example 19 may include the method of Example 15 and may further include positioning one or more additional layers to form the embedded AR stack, wherein the one or more additional layers correspond to different refractive indices.

Example 20 may include the method of Example 15 and may further include one or more additional layers positioned to form meta-surfaces, multiplexing-demultiplexing, polarization splitting/combining or other such features.

Example 21 may include the method of Example 15, in which the second oxide layer may be formed to a thickness of greater than 2 microns.

Example 22 may include the method of Example 15 in which the silicon carrier may be removed after inversion, backgrinding, and/or optical component processing.

Example 23 may include the method of Example 15 in which the embedded AR stack may be configured to minimize reflection losses when coupling light between silicon, air and/or glass.

Example 24 may include the method of Example 15 and may further include utilizing a wafer or chiplet in a range between substantially 100 mm and 300 mm during fabrication to enable larger oxide thicknesses for improved optical performance.

Example 25 may include the method of Example 15, in which the thinned first silicon layer may include a thickness of substantially 5-20 microns.

Example 26 may include the method of Example 15 in which the operation of facet creation and anti-reflective coating application may be optimized for use in telecommunications, data center networking, or other optical applications.

Example 27 may include the method of Example 15 and may further include applying an AR coating to the facet, in which the AR coating may include one or more layers with varying refractive indices configured to minimize reflection losses and improve optical coupling efficiency.

Example 28 may include the method of Example 15, in which etching the vertical facet into the thinned first silicon layer further may include creating the vertical facet at an angle substantially between 4° and 25° relative to a surface of the silicon layer, the vertical facet configured to minimize backreflection of light within the photonic device.

Example 29 may include the method of Example 15 and may further include applying a high-reflectivity (HR) coating to the angled facet to increase reflection of light within the photonic device. HR coating may be defined as >95% reflectivity.

Example 30 may include the method of Example 15 and may further include filling in a cavity formed after etching the angled facet with an oxide material.

Example 31 may include the method of Example 30 in which subsequent to applying the HR coating, the oxide material may be utilized to planarize the surface and maintain flatness prior to the vertical facet formation, and wherein the vertical facet may be formed with or without an AR coating applied subsequent to etching the second facet.

Example 32 may include a method of manufacturing a photonic device with an embedded anti-reflective (AR) stack, the method including: providing a first silicon layer; forming a first oxide layer on the first silicon layer to create a buffer layer with a refractive index configured for seamless transition to optical components; positioning a second silicon layer on the first oxide layer to form a first layer of the embedded AR stack; forming a second oxide layer on the second silicon layer to create a second layer of the embedded AR stack, the second oxide layer having a refractive index of approximately 1.5; etching a vertical facet into the second silicon layer, configured for light coupling; and etching a second angled facet into the second silicon layer, the angled facet being configured to redirect light vertically through the embedded AR stack.

Example 33 may include the method of Example 32 in which the first oxide layer may include a thickness of at least 2 microns, and wherein the second oxide layer may be formed to a thickness of less than 1 micron.

Example 34 may include a photonic device including: a first silicon layer configured for structural stability during processing; a first oxide layer intended to enable seamless transition to adjacent materials such as air or glass; a second silicon layer to form one of the layers of AR coating and disposed adjacent to the first oxide layer; a second oxide layer to form a second layer of AR coating and disposed adjacent to the first silicon layer, the second oxide layer having a refractive index of substantially 1.5; a third silicon layer disposed adjacent to the second oxide layer, for creation of photonic elements, including transmissive facets and/or angled mirror facets; a vertical or substantially vertical facet etched into the second silicon layer; and an angled facet etched into the second silicon layer, the facet being angled for light redirection vertically through the embedded AR stack.

Example 35 may include the photonic device of Example 34 in which the vertical or substantially vertical facet etched into the second silicon layer may include an AR coating including a plurality of AR layers.

Example 36 may include the photonic device of Example 35 in which at least one or more of the plurality of AR layers may correspond to varying refractive indices relative to one another, the varying refractive indices configured to minimize reflection losses and increase an optical transmission efficiency.

Example 37 may include the photonic device of Example 34, in which the photonic device may be configured to couple light through the vertical facet via the embedded AR stack for enhanced optical transmission and minimal optical loss.

Example 38 may include the photonic device of Example 34, in which the angled facet may be etched using a wet etching process with a standard (100) silicon orientation, resulting in a facet angle of approximately 54.7°.

Example 39 may include the photonic device of Example 34, in which the facet may be etched using a bias-cut silicon ingot or alternate seed crystals, resulting in a facet angle between approximately 35° and 55°.

Example 40 may include the photonic device of Example 34, in which the facet may be etched with advanced processing techniques such as greyscale or nano-imprint lithography, resulting in a facet angle between approximately 35° and 55°.

Example 41 may include the photonic device of Example 34, in which the embedded anti-reflective coating may include at least two layers with different refractive indices, configured to reduce reflection losses between silicon and air and/or glass.

Example 42 may include the photonic device of Example 34, in which the first oxide layer may have a thickness of greater than 2 microns.

Example 43 may include the photonic device of Example 34, in which the third silicon layer may be thinned to a thickness of substantially 5-20 microns through a backgrinding or chemical-mechanical polishing (CMP) process.

Example 44 may include the photonic device of Example 34, in which the first silicon may be removed or thinned during subsequent integration process with other photonic devices.

Example 45 may include the photonic device of Example 34, in which the two layers of SiO2 and Si that form the embedded AR stack may be replaced with other materials or increased in number and vary in thicknesses.

Example 46 may include the photonic device of Example 34, in which the device may be fabricated using a process that includes layer deposition, wafer bonding, inversion, backgrinding, facet etching, and anti-reflective coating application.

Example 47 may include the photonic device of Example 34, in which the embedded layers may be configured to provide multiplexing (mux) and demultiplexing (demux) capability, enabling the separation or combination of different wavelengths of light within the photonic device.

Example 48 may include the photonic device of Example 34, in which the angled facet etched into the second silicon layer may be subsequently filled with an oxide material, thereby enabling planarization of the surface for further processing steps.

Example 49 may include the photonic device of Example 34, in which the thicknesses of the first oxide layer and the second silicon layer may be between 0.1 to 1 micron (μm) to ensure optimal refractive index matching and structural stability within the photonic device.

Example 50 may include a photonic device including: an SOI wafer with a first silicon layer followed by a buried oxide layer and a top silicon layer; the top silicon layer etched to form a pyramid structure with specific side-wall angles for the critical reflective surfaces; the oxide layer enabled to allow for hybrid or fusion bonding or similar. The sidewalls may be formed to enable light redirection through a high-reflectivity surface.

Example 51 may include the photonic device of Example 50, in which the sidewall is coated with a dielectric stack, metal mirror and/or combination thereof to form a high-reflectivity mirror.

Example 52 may include the photonic device of Example 50, in which the sidewall is coated with a dielectric stack to form an anti-reflective coating such that the light propagates inside the structure and reflects off the far sidewall through TIR.

Example 53 may include the photonic device of Example 52, in which the far sidewall is coated with a high-reflectivity surface made through dielectric stacks and/or metal.

Example 54 may include the photonic device of Example 52, in which the substrate has an embedded dielectric stack to form AR functionality.

Example 55 may include the photonic device of Example 52, in which the substrate has an embedded mux/demux structure to separate light via wavelength and/or polarization.

Example 56 may include the photonic device of Example 52, in which the substrate has an embedded meta-surface to manipulate the light shape and/or propagation direction or other such manipulations of light by wavelength and/or polarization.

Example 57 may include the photonic device of Example 52, in which any combination of AR, mux/demux, and meta-surfaces are integrated.

Example 58 may include the photonic device of Example 52 and/or 50, in which electrical vias are incorporated to enable electrical connectivity to other components.

Example 59 may include a device including a first layer having an angled facet with a high-reflectivity surface; and a second layer positioned below the first layer, wherein the second layer comprises oxide to facilitate one or more of hybrid or fusion bonding to a photonic integrated circuit (PIC).

Example 60 may include the device of Example 59 in which the high-reflectivity surface is formed using one or more of: alternating dielectric layers with differing refractive indices, metal, or total-internal reflection (TIR).

Example 61 may include the device of Example 59 in which the second layer further includes a plurality of electrical vias to facilitate vertical electrical connections.

Example 62 may include the device of Example 59 in which the first layer includes one or more of oxide or silicon.

Example 63 may include the device of Example 59 in which the angled facet of the first layer has an angle in a range of from 35° to 55°.

Example 64 may include the device of Example 59 in which the first layer includes a first facet and a second facet, in which the first facet facilitates propagation using one or more of an index of refraction matched to the surrounding environment or through the inclusion of AR coating, and in which the second facet has a high-reflectivity surface caused by one or more of mirror formation via one or more of dielectric or metal layers or via total internal reflection (TIR).

Example 65 may include the device of Example 64 in which the first layer includes the AR coating, in which the AR coating includes at least two layers with different refractive indices to reduce reflection losses between silicon and surrounding oxide.

Example 66 may include the device of Example 59 in which the angled facet is formed to a selected angle using one or more of wet etching, greyscale or nano-imprint lithography and transfer etching.

Example 67 may include the device of Example 59 in which the second layer has a thickness of from 0.1 microns to 100 microns.

Example 68 may include the device of Example 59, further including an additional layer positioned below the second layer, wherein the additional layer is formed of one or more of dielectric stacks, micro-lenses or meta-surfaces to facilitate manipulation of the beam by one or more of wavelength, polarization, shape, phase, or angle.

Example 69 may include a method, including, etching a first silicon wafer to create a structure with one or more sloped sidewalls, an angle of the one or more sloped sidewalls being determined by a crystallographic orientation of the silicon wafer; depositing a coating on at least one sloped sidewall of the one or more sloped sidewalls to create a surface for manipulating light; and providing an oxide layer to form a planar surface to facilitate one or more of hybrid or fusion bonding.

Example 70 may include the method of Example 69 in which the coating is a high-reflectivity (HR) coating formed using one or more of: dielectric layers with different refractive indices and thicknesses, metal, or total internal reflection (TIR).

Example 71 may include the method of Example 69 in which the coating is an anti-reflective (AR) coating comprising at least two layers with different refractive indices and thicknesses to reduce reflection losses from silicon.

Example 72 may include the method of Example 69, in which the oxide layer is formed using deposition and planarization.

Example 73 may include the method of Example 69 in which the oxide layer is part of the starting wafer material.

Example 74 may include the method of Example 69, in which electrical vias are formed through the oxide layer or integrated using hybrid or fusion bonding of an additional wafer to provide structural support.

Example 75 may include the method of Example 69 in which the structure in the first layer is formed using remaining silicon.

Example 76 may include the method of Example 69, in which the structure in the first layer is formed without silicon by adding oxide and removing starting silicon material.

Example 77 may include the method of Example 69, further including one or more of dielectric stacked materials, micro-lenses or meta surfaces positioned below the oxide layer to manipulate light.

Example 78 may include the method of Example 69 in which the oxide has a thickness in a range of from 0.1 μm to 100 μm.

The embodiments described herein may be embodied in systems, apparatus, methods, computer programs and/or articles depending on the desired configuration. Any methods or the logic flows depicted in the accompanying figures and/or described herein do not necessarily require the particular order shown, or sequential order, to achieve desirable results. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. The implementations described above can be directed to various combinations and subcombinations of the disclosed features and/or combinations and subcombinations of further features noted above. Furthermore, above described advantages are not intended to limit the application of any issued claims to processes and structures accomplishing any or all of the advantages. Furthermore, any reference to this disclosure in general or use of the word “embodiment” in the singular is not intended to imply any limitation on the scope of the claims set forth below. Multiple embodiments may be set forth according to the limitations of the multiple claims issuing from this disclosure, and such claims accordingly define the embodiment(s) herein, and their equivalents, that are protected thereby.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

Although the description provided above provides detail for the purpose of illustration based on what is currently considered to be the most practical and preferred embodiments, it is to be understood that such detail is solely for that purpose and that the disclosure is not limited to the expressly disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

1. A device, comprising:
a first layer having an angled facet with a high-reflectivity surface; and
a second layer positioned below the first layer, wherein the second layer comprises oxide to facilitate one or more of hybrid or fusion bonding to a photonic integrated circuit (PIC).

2. The device of claim 1, wherein the high-reflectivity surface is formed using one or more of:
alternating dielectric layers with differing refractive indices,
metal, or
total-internal reflection (TIR).

3. The device of claim 1, wherein the second layer further comprises a plurality of electrical vias to facilitate vertical electrical connections.

4. The device of claim 1, wherein the first layer comprises one or more of oxide or silicon.

5. The device of claim 1, wherein the angled facet of the first layer has an angle in a range of from 35° to 55°.

6. The device of claim 1, wherein the first layer comprises a first facet and a second facet, wherein the first facet facilitates propagation using one or more of an index of refraction matched to a surrounding environment or through inclusion of anti-reflective (AR) coating, and wherein the second facet has a high-reflectivity surface caused by one or more of mirror formation via one or more of dielectric or metal layers or via total internal reflection (TIR).

7. The device of claim 6, wherein the first layer comprises the AR coating, wherein the AR coating comprises at least two layers with different refractive indices to reduce reflection losses between silicon and surrounding oxide.

8. The device of claim 1, wherein the angled facet is formed to a selected angle using one or more of wet etching, greyscale or nano-imprint lithography and transfer etching.

9. The device of claim 1, wherein the second layer has a thickness of from 0.1 microns to 100 microns.

10. The device of claim 1, further comprising an additional layer positioned below the second layer, wherein the additional layer is formed of one or more of dielectric stacks, micro-lenses or meta-surfaces to facilitate manipulation of a beam by one or more of wavelength, polarization, shape, phase, or angle.

11. A method, comprising:
etching a first silicon wafer to create a structure with one or more sloped sidewalls, an angle of the one or more sloped sidewalls being determined by a crystallographic orientation of the silicon wafer;
depositing a coating on at least one sloped sidewall of the one or more sloped sidewalls to create a surface for manipulating light; and
providing an oxide layer to form a planar surface to facilitate one or more of hybrid or fusion bonding.

12. The method of claim 11, wherein the coating is a high-reflectivity (HR) coating formed using one or more of:
dielectric layers with different refractive indices and thicknesses,
metal, or
total internal reflection (TIR).

13. The method of claim 11, wherein the coating is an anti-reflective (AR) coating comprising at least two layers with different refractive indices and thicknesses to reduce reflection losses from silicon.

14. The method of claim 11, wherein the oxide layer is formed using deposition and planarization.

15. The method of claim 11, wherein the oxide layer is part of a starting wafer material.

16. The method of claim 11, wherein electrical vias are formed through the oxide layer or integrated using hybrid or fusion bonding of an additional wafer to provide structural support.

17. The method of claim 11, wherein the structure in a first layer is formed using remaining silicon.

18. The method of claim 11, wherein the structure in a first layer is formed without silicon by adding oxide and removing starting silicon material.

19. The method of claim 11, further comprising one or more of dielectric stacked materials, micro-lenses or meta surfaces positioned below the oxide layer to manipulate light.

20. The method of claim 11, wherein the oxide has a thickness in a range of from 0.1 μm to 100 μm.
